(19) United States
(12) Patent Application Publication
(10) Pub. No.: US 2026/0155291 A1
(43) Pub. Date: Jun. 4, 2026

(54) MAGNETIC CORE, MAGNETIC COMPONENT, AND ELECTRONIC DEVICE

(71) Applicant: TDK CORPORATION, Tokyo (JP)

(72) Inventors: Kyohei TAKAHASHI, Tokyo (JP); Hiroshi Ito, Tokyo (JP)

(73) Assignee: TDK CORPORATION, Tokyo (JP)

(21) Appl. No.: 19/403,591

(22) Filed: Nov. 28, 2025

(30) Foreign Application Priority Data
Nov. 29, 2024 (JP) 2024-207827
Nov. 29, 2024 (JP) 2024-207828
Sep. 16, 2025 (JP) 2025-153593
Sep. 16, 2025 (JP) 2025-153596

(51) Int. Cl. H01F 27/255; H01F 1/20

(52) U.S. Cl. CPC H01F 27/255; H01F 1/20

(57) ABSTRACT

A magnetic core includes specific particles. The magnetic core includes a surface portion at a small distance from an outermost surface of the magnetic core and a central portion at a large distance from the outermost surface of the magnetic core. The specific particles include respective oxide phases with a specific thickness. The specific particles in the surface portion and the specific particles in the central portion have a specific relation of the thickness of the oxide phases. Alternatively, a magnetic core includes a soft magnetic metal particle. The soft magnetic metal particle includes an oxide phase at a surface of the particle. A maximum-thickness portion and an opposite maximum-thickness portion of the oxide phase have a specific relation.

### TECHNICAL FIELD

The present disclosure relates to a magnetic core, a magnetic component, and an electronic device.

### BACKGROUND

Patent Document 1 discloses an invention related to a coil component. Thickening an oxide film of a metal magnetic particle located at an interface between a magnetic body and an outer electrode can improve close contact between the magnetic body and the outer electrode while a low direct-current resistance is maintained.
Patent Document 1: JP Patent Application Laid Open No. 2023-103954

### SUMMARY

To achieve the above object, a magnetic core according to a first aspect of the present disclosure is a magnetic core including specific particles, wherein
the magnetic core includes a surface portion at a distance of 100 μm or less from an outermost surface of the magnetic core and a central portion at a distance of more than 100 μm from the outermost surface of the magnetic core,
the specific particles include soft magnetic metal particles including respective oxide phases with a thickness of 0.025 μm or more at surfaces of the soft magnetic metal particles,
at least the surface portion includes the specific particles, and
T1≥0.050, T2≤0.500, and T1>T2 are satisfied, where
T1 [μm] denotes an average thickness of the oxide phases of the specific particles in the surface portion, and
T2 [μm] denotes an average thickness of the oxide phases of the specific particles in the central portion.

At least some of the specific particles may contain Fe and/or Co.

0.200≤T1≤5.000 may be satisfied.

To achieve the above object, a magnetic core according to a second aspect of the present disclosure is a magnetic core including a soft magnetic metal particle, wherein the soft magnetic metal particle includes an oxide phase at a surface of the soft magnetic metal particle, and
0<T4/T3≤0.98 is satisfied, where
T3 denotes a length of a maximum-thickness portion of the oxide phase,
T4 denotes a length of an opposite maximum-thickness portion of the oxide phase,
the maximum-thickness portion denotes a portion where a length of the oxide phase along a specific straight line is maximized,
the opposite maximum-thickness portion denotes a portion opposite the maximum-thickness portion relative to a center of the soft magnetic metal particle along the specific straight line, and
the specific straight line denotes a freely drawn straight line containing the center and the maximum-thickness portion in a cross-section of the magnetic core.

The soft magnetic metal particle may contain Fe and/or Co.

0<T4/T3≤0.90 may be satisfied.

The following is common to the first aspect and the second aspect.

A magnetic component of the present disclosure includes the above magnetic core.

An electronic device of the present disclosure includes the above magnetic core.

### BRIEF DESCRIPTION OF THE DRAWING(S)

FIG. 1 is a SEM image of a specific particle of a first embodiment.

FIG. 2 is a schematic view showing a location of an outermost surface of a magnetic core.

FIG. 3 is a schematic view showing a location of an outermost surface of a magnetic core.

FIG. 4 is a SEM image of the vicinity of a surface of a magnetic core of a second embodiment.

FIG. 5 is a schematic view of a cross-section of a soft magnetic metal particle of the second embodiment.

### DETAILED DESCRIPTION

It is an object of the present disclosure to provide a magnetic core having improved withstand voltage while maintaining suitable relative permeability.

### First Embodiment

Hereinafter, a magnetic core according to a first embodiment of the present disclosure is described with reference to the drawings.

The magnetic core according to the present embodiment includes a surface portion 3 at a distance of 100 μm or less from an outermost surface of the magnetic core and a central portion 4 at a distance of more than 100 μm from the outermost surface.

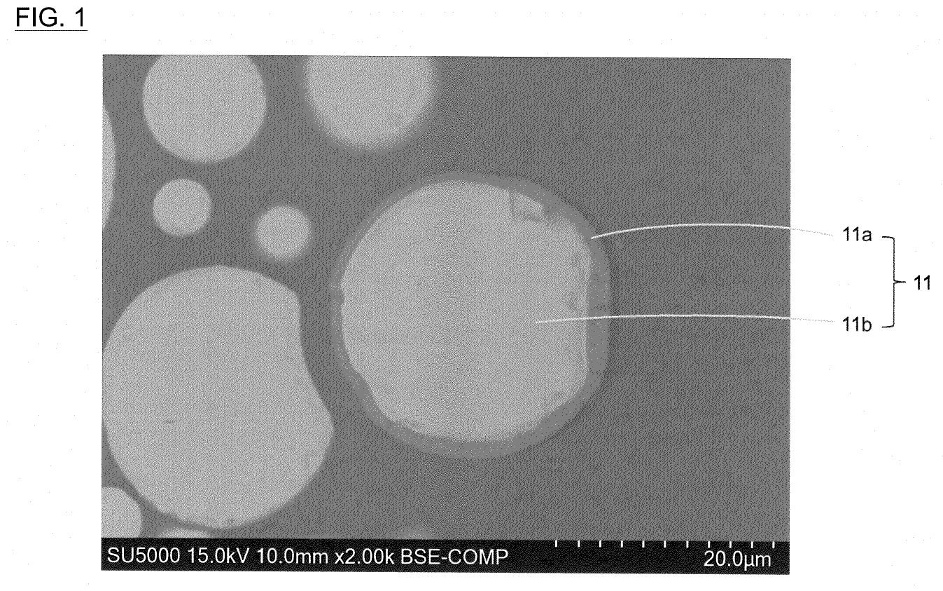

The magnetic core according to the present embodiment includes specific particles 11 shown in FIG. 1 at least in the surface portion 3.

Each of the specific particles 11 is a soft magnetic metal particle including an oxide phase 11a with a thickness of 0.025 μm or more at a surface of the particle. In other words, the specific particle 11 is a soft magnetic metal particle including a particle body 11b and the oxide phase 11a, which covers the particle body 11b and has a thickness of 0.025 μm or more. Note that a soft magnetic metal particle that includes only an oxide phase with a thickness of less than 0.025 μm is not deemed to be a specific particle 11.

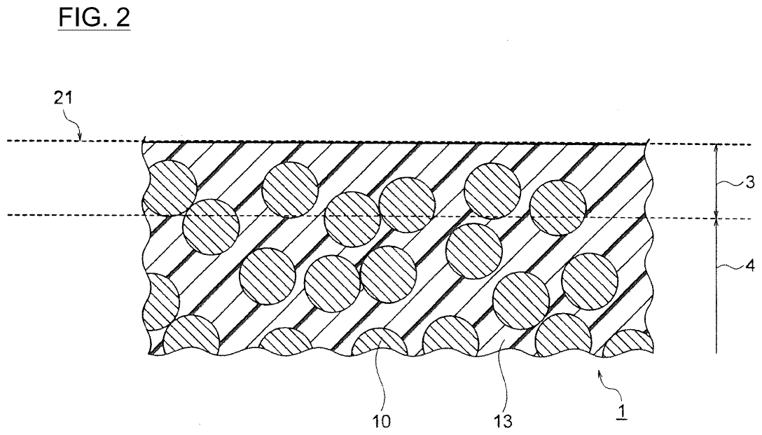

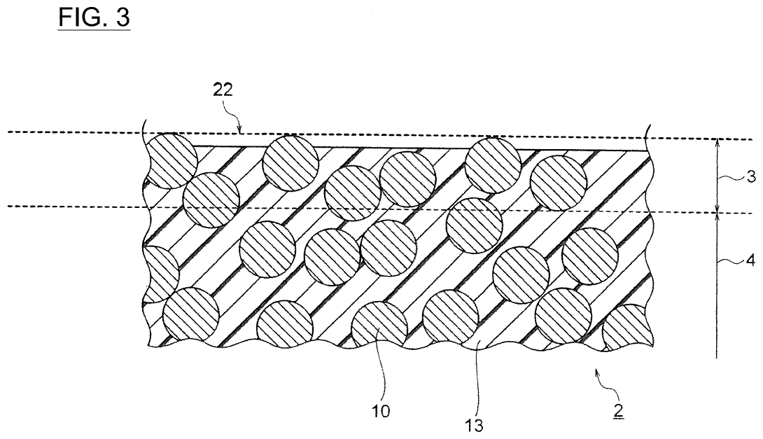

The outermost surface according to the present embodiment is described with reference to FIGS. 2 and 3. A magnetic core 1 shown in FIG. 2 and a magnetic core 2 shown in FIG. 3 have a structure in which spaces between soft magnetic metal particles 10 are filled with resin 13.

In the present embodiment, the outermost surface means a plane that is in contact with the magnetic core's material located farthest out and is parallel to a surface of the magnetic core.

Each of FIGS. 2 and 3 shows part of the vicinity of a surface of the magnetic core. The surface is on the upper side.

In FIG. 2, the surface of the magnetic core 1 corresponds to a surface of the resin 13, and no soft magnetic metal particles 10 are present at the surface of the magnetic core 1. In this situation, the surface of the magnetic core 1 is an outermost surface 21 as shown in FIG. 2.

In FIG. 3, some soft magnetic metal particles 10 protrude from the resin 13 at the surface of the magnetic core 2. In this situation, a plane that is in contact with a surface of the most protruding soft magnetic metal particle 10 from the surface of the magnetic core 2 among all soft magnetic metal particles 10 at the surface of the magnetic core 2 and is parallel to the surface of the magnetic core 2 is an outermost surface 22.

The magnetic core according to the present embodiment satisfies T1≥0.050, T2≤0.50, and T1>T2, where T1 [μm] denotes the average thickness of the oxide phases 11a of the specific particles 11 in the surface portion 3 and T2 [μm] denotes the average thickness of the oxide phases 11a of the specific particles 11 in the central portion 4.

There is no upper limit of T1. The upper limit of T1 may be, for example, 10.0 or less or 5.0 or less. More specifically, 0.050≤T1≤10.0 may be satisfied, or 0.20≤T1≤5.0 may be satisfied. There is no lower limit of T2. The lower limit of T2 may be, for example, 0.000 or more. More specifically, 0.000≤T2≤0.50 may be satisfied.

T1−T2≥0.001 may be satisfied. T1−T2≥0.01 may be satisfied.

The larger the thicknesses of the oxide phases 11a relative to the particle sizes of the specific particles 11, the smaller the relative permeability of the magnetic core tends to be.

The average thickness T1 of the oxide phases 11a of the specific particles 11 in the surface portion 3 is the average thickness calculated by averaging the thicknesses of the oxide phases 11a of all the specific particles 11 in the surface portion 3. The average thickness T2 of the oxide phases 11a of the specific particles 11 in the central portion 4 is the average thickness calculated by averaging the thicknesses of the oxide phases 11a of all the specific particles 11 in the central portion 4.

In a situation where the specific particles 11 are located on a boundary line between the surface portion 3 and the central portion 4, those specific particles 11 are deemed to be those included in the surface portion 3.

That is, in the magnetic core according to the present embodiment, the surface portion 3 includes the soft magnetic metal particles including thicker oxide phases than those of the central portion 4. This enables the magnetic core to have improved withstand voltage while maintaining suitable relative permeability.

In a situation where the surface portion 3 includes no specific particles 11, T1 is deemed to be T1=0.000. In a situation where the central portion 4 includes no specific particles 11, T2 is deemed to be T2=0.000.

The specific particles 11 may account for any area percentage of the surface portion 3 in a cross-section of the magnetic core. The area percentage may be, for example, 1% or more and 85% or less.

At least some specific particles 11 may contain Fe and/or Co.

The particle body 11b may have any composition. The particle body 11b may contain, for example, at least one element selected from Fe, Co, and Ni. The particle body 11b may contain at least one element selected from P, Si, B, Na, Al, Ca, Bi, Ba, Zn, C, Nb, Hf, Zr, Cu, Ta, Mo, W, Ti, and V, which are elements generally contained in a soft magnetic metal particle.

The particle body 11b may have any total content of Fe, Co, and Ni. The total content may be, for example, 70 at % or more and 100 at % or less. The particle body 11b may have any total content of P, Si, B, Na, Al, Ca, Bi, Ba, and Zn. The total content may be, for example, 0 at % or more and 30 at % or less. The particle body 11b may have any total content of C, Nb, Hf, Zr, Cu, Ta, Mo, W, Ti, and V. The total content may be, for example, 0 at % or more and 10 at % or less. Because the proportion of the particle body 11b is generally significantly larger than the proportion of the oxide phase 11a, it can be assumed that the composition of the particle body 11b and the composition of the corresponding specific particle 11 are substantially the same. In a situation where the proportion of the particle body 11b is not significantly larger than the proportion of the oxide phase 11a, the composition of the particle body 11b may be analyzed for determination. The composition of the particle body 11b may be determined using, for example, a composition analysis with cross-sectional SEM-EDS or STEM-EDS.

The particle body 11b may further contain elements other than Fe, Co, Ni, P, Si, B, Na, Al, Ca, Bi, Ba, Zn, C, Nb, Hf, Zr, Cu, Ta, Mo, W, Ti, and V to the extent that magnetic properties of the specific particle 11 are not significantly impaired. The particle body 11b may have a total content of elements other than Fe, Co, Ni, P, Si, B, Na, Al, Ca, Bi, Ba, Zn, C, Nb, Hf, Zr, Cu, Ta, Mo, W, Ti, and V of, for example, 5 mass % or less.

The composition of the oxide phase 11a is not limited except that the oxide phase 11a contains an oxide. The oxide phase 11a may contain, for example, an oxide of at least one element selected from the elements contained in the particle body 11b. That is, the oxide phase 11a is a phase containing an oxide.

The oxide phase 11a may be composed of an oxide formed by oxidation of the particle body 11b. The composition of the oxide phase 11a and the composition of the particle body 11b may, for example, match 50% or more in terms of atomicity without oxygen and carbon being taken into account.

The oxide phase 11a may contain Co. Co being contained in the oxide phase 11a easily improves withstand voltage properties. Specifically, the ratio of the Co content of the oxide phase 11a to the total of the Fe content, Co content, and P content of the oxide phase 11a (hereinafter, this ratio may simply be referred to as Co/a) may be 0.10 or more and 1.00 or less or may be 0.17 or more and 0.70 or less in terms of atomicity.

The oxide phase 11a may contain P. The ratio of the P content of the oxide phase 11a to the total of the Fe content, Co content, and P content of the oxide phase 11a (hereinafter, this ratio may simply be referred to as P/a) may be 0.01 or more and 1.00 or less or may be 0.10 or more and 0.50 or less in terms of atomicity. In a situation where, in particular, the oxide phase 11a contains Co and P/a is 0.10 or more and 0.50 or less, the withstand voltage properties easily improve.

The oxide phase 11a may have a crack. The crack may, for example, continue from a surface of the oxide phase 11a to a surface of the particle body 11b or end somewhere inside the oxide phase 11a.

The specific particle 11 may have any particle size. The particle size may be, for example, 0.5 μm or more and 100 μm or less.

The soft magnetic metal particles according to the present embodiment may have any microstructure. The microstructure of the soft magnetic metal particles may be an amorphous structure, a nanocrystalline structure including nanocrystals, or a crystalline structure.

Soft magnetic metal particles including nanocrystals may be provided by heating amorphous soft magnetic alloy particles at 400° C. to 700° C.

In this context, an amorphous structure means a structure that almost does not have long-range order such as that of a crystal and has a material state with an amorphous ratio X of 85% or more. Amorphous structures include a structure containing only an amorphous solid and a hetero-amorphous structure. A hetero-amorphous structure means a structure in which initial fine crystals are present in an amorphous solid. The initial fine crystals of the hetero-amorphous structure have an average crystallite size of preferably 0.1 nm or more and 10 nm or less.

A nanocrystalline structure means a structure that has an amorphous ratio X of less than 85% and has a material state including nanocrystals having an average crystallite size of 0.5 nm or more and 30 nm or less. The crystallites of the nanocrystalline structure have a maximum size of preferably 100 nm or less.

In contrast, a crystalline metal magnetic material has a crystalline structure different from the amorphous structure or the nanocrystalline structure. A crystalline structure means a structure that has an amorphous ratio X of less than 85% and has a material state having an average crystallite size of 100 nm or more.

The amorphous ratio X (unit: %) is represented by X=(P_{A}/(P_{C}+P_{A}))×100, where P_{C} denotes a crystal proportion and P_{A} denotes an amorphous proportion. In a situation where XRD is used for calculation of the amorphous ratio X, crystal scattering integrated intensity Ic measured using XRD may be deemed to be P_{C}, and amorphous scattering integrated intensity Ia measured using XRD may be deemed to be P_{A}. In a situation where EBSD or an electron microscope is used for calculation of the amorphous ratio X, the area proportion of a crystal portion of a particle may be deemed to be P_{C}, and the area proportion of an amorphous portion of the particle may be deemed to be P_{A}.

Examples of materials of soft magnetic alloy particles with an amorphous microstructure include Fe—Si—B alloys, Fe—B—Si—C alloys, Fe—B—Si—C—Cr alloys, Fe—Co—B—P—Si—Cr alloys, Fe—Co—B—P—Si alloys, and Fe—Co—B—P—Si—C alloys.

Examples of materials of soft magnetic alloy particles with a nanocrystalline microstructure include Fe—Si—B—Nb—Cu alloys, Fe—B—Nb alloys, Fe—B—Nb—P alloys, Fe—B—P—Si—Cu alloys, Fe—B—P—Si—Nb—Cr alloys, Fe—Co—B—P—Si—Cu alloys, and Fe—Co—B—P—Si—Nb alloys.

Examples of materials of soft magnetic alloy particles with a crystalline microstructure include pure metal Fe, pure metal Co, pure metal Ni, Fe—Co alloys, Fe—Si alloys, Fe—Ni alloys, Fe—Co—Si alloys, Fe—Si—Cr alloys, Fe—Co—Si—Cr alloys, Fe—Co—V alloys, Fe—Si—Al alloys, Fe—Si—Al—Ni alloys, and Fe—Co—Si—Al alloys.

Hereinafter, a method of manufacturing the magnetic core according to the present embodiment is described.

Any method of manufacturing a soft magnetic metal powder according to the present embodiment may be used. The soft magnetic metal powder can be manufactured using, for example, a water atomization method, a gas atomization method, a carbonyl method, or a spray pyrolysis method. The soft magnetic metal powder can also be manufactured using, for example, a method involving pulverization of a metal ribbon. Described below is a method of manufacturing the soft magnetic metal powder according to the present embodiment using the gas atomization method.

First, raw materials of constituent elements of metal particles included in the soft magnetic metal powder are prepared and are weighed to provide an intended composition of the metal particles. The raw materials of the elements are melted to provide a master alloy. Any melting method may be used. The raw materials of the elements may be melted using, for example, high-frequency heating in a chamber at a predetermined degree of vacuum.

Then, the master alloy is heated for melting to provide molten metal. The temperature of the molten metal is controlled according to the melting point of the alloy having the intended composition and/or the melting points of the raw materials of the above elements. The temperature may be, for example, 1200° C. to 1600° C.

Then, the molten metal is sprayed in a chamber to provide the powder. Specifically, the molten metal is discharged from a discharge port to a cooling portion of the chamber. At this time, a high-pressure gas is sprayed to the discharged molten metal. Jets of the high-pressure gas cut and scatter the molten metal in the chamber. Colliding with the cooling portion (cooling water), the scattered molten metal is rapidly quenched and solidified to become the soft magnetic metal powder including the metal particles 10. In a situation where the water atomization method is used, water is sprayed instead of the high-pressure gas.

The high-pressure gas may be of any type. Examples of such gases include inert gases, such as a nitrogen gas, an argon gas, and a helium gas. The high-pressure gas may also be a reducing gas, such as an ammonia decomposition gas.

The pressure of the sprayed high-pressure gas is not limited. The pressure may be 2.0 to 10.0 MPa. The spray amount of the discharged molten metal is also not limited. The spray amount may be 0.5 to 16.0 kg/min. Controlling the ratio of the pressure of the high-pressure gas to the spray amount of the molten metal can control the particle size or the like of the soft magnetic metal powder.

The particle size of the soft magnetic metal powder may be controlled using classification.

Moreover, the powder resulting from quenching using cooling water may be provided with a coating film.

The coating film may be of any type. The coating film may be a film containing, for example, an inorganic material. Examples of inorganic materials include phosphates, BN, SiO₂, MgO, Al₂O₃, phosphate based glass, silicate based glass, borosilicate based glass, and bismuthate based glass.

Examples of phosphate based glass include P—Zn—Al—O based glass and P—Zn—Al—R—O based glass (“R” includes at least one element selected from alkaline metals). Examples of silicate based glass include Si—O based glass. Examples of borosilicate based glass include Ba—Zn—B—Si—Al—O based glass. Examples of bismuthate based glass include Bi—Zn—Al—O based glass and Bi—Zn—B—Si—Al—O based glass.

Any method of forming the coating film may be used. A well-known method selected according to the type of the coating film may be used. Examples of methods of forming the coating film include a heat treatment, a phosphate treatment, mechanical alloying, a silane coupling treatment, and a hydrothermal synthesis.

Some of the methods of forming the coating film are more specifically described below.

In a situation where a film containing SiO₂ (which may hereinafter be referred to as a SiO₂ film) is formed as the coating film, a solution including a silane coupling agent as a Si source may be sprayed to the powder. Alternatively, the solution including the silane coupling agent may permeate through the powder, and the powder may then be dried and/or heat treated.

The silane coupling agent may be of any type. Examples thereof include tetramethoxysilane (TMOS), tetraethoxysilane (TEOS), and hexyltrimethylsilane. Particularly preferred is TEOS.

The solution including the silane coupling agent may include any solvent. Examples of solvents include water, ethanol, acetone, and isopropyl alcohol. Controlling the silane coupling agent concentration of the solution including the silane coupling agent, spray amount per unit time, permeation treatment time, or the like can control the thickness of the coating film. The higher the silane coupling agent concentration, the larger the spray amount per unit time, and the longer the permeation treatment time, the larger the thickness of the coating film.

In a situation where a film containing a phosphate (which may hereinafter be referred to as a phosphate film) is formed as the coating film, the phosphate treatment can be used. Specifically, first, a phosphate with an additional element or phosphoric acid is dissolved in a solvent (e.g., water and alcohol) to prepare a treatment solution. The treatment solution permeates through the powder or is sprayed to the powder. Then, the powder is dried to form the phosphate film on a surface of the powder. Examples of additional elements include alkaline metal elements, alkaline earth metal elements, Zn, and Al.

In a situation where a glass based film is formed as the coating film, a mechanochemical method with a mechanofusion apparatus can be used. Specifically, in a treatment of forming the coating film using the mechanochemical method, the powder before being provided with the coating film and a powdery coating agent containing constituent elements of the coating film are introduced into a rotor of the mechanofusion apparatus, and the rotor is rotated. Inside the rotor is a press head. As the rotor rotates, the mixture of the powder before being provided with the coating film and the coating agent is compressed in a space between an inner wall surface of the rotor and the press head. This generates frictional heat. The frictional heat softens the coating agent, which adheres, using compressive effect, to a surface of the powder before being provided with the coating film to form the coating film of oxide glass.

Any method of manufacturing the magnetic core according to the present embodiment may be used. Hereinafter, a method of manufacturing a dust core as the magnetic core is described. That is, a method of manufacturing the magnetic core using pressure-molding is described.

The soft magnetic metal powder according to the present embodiment and resin are kneaded to provide a resin compound. The resin compound may be a granulated powder. At this time, a soft magnetic metal powder other than the soft magnetic metal powder according to the present embodiment and/or a non-magnetic powder or the like may be added to the resin compound. A modifier, a preservative, a dispersant, or the like may also be added. A mold is filled with the resin compound, and pressure-molding is performed. Then, the resin is hardened. This provides the magnetic core.

First, the soft magnetic metal powder and the resin are mixed. Mixing the powder with the resin makes it easier to provide a pressed body having high strength by molding. The resin may be of any type. Examples of resins include a phenol resin and an epoxy resin. The amount of the resin added is not limited. With respect to a total mass of 100 parts by mass of various magnetic materials, the amount of the resin may be 0.5 parts by mass or more and 5.0 parts by mass or less in total.

The mixture of the soft magnetic metal powder and the resin is granulated to provide the granulated powder. Any granulation method may be used. For example, a stirrer may be used for granulation. The granulated powder may have any particle size.

The resultant granulated powder is pressure-molded to provide the pressed body. The molding pressure is not limited. The pressure (surface pressure) may be, for example, 98 MPa (0.1 t/cm²) or more and 1960 MPa (20 t/cm²) or less.

Hardening the resin included in the pressed body can provide the magnetic core. Any hardening method may be used. A heat treatment may be performed under conditions that can harden the resin.

To the resultant magnetic core, an oxide phase formation treatment is performed. Through the oxide phase formation treatment, surfaces of the particle bodies included in the magnetic core are oxidized to form the oxide phases. Because the soft magnetic metal particles close to a surface of the magnetic core are more easily provided with thicker oxide phases, T1 easily becomes larger than T2.

Described below is a method of performing the oxide phase formation treatment.

First, the magnetic core and water are sealed in a metal sealed container. The amount of water (sealed amount) is not limited. The amount may be, for example, 0.1 parts by mass or more and 25.0 parts by mass or less with respect to 100 parts by mass magnetic core.

Then, the sealed container is filled with a gas. Any method of filling the container with the gas may be used. For example, the sealed container may once be decompressed and then be filled with the gas and have pressure applied. The gas may be of any type. The gas may be, for example, compressed air, a nitrogen gas, or an argon gas. The pressure inside the sealed container is not limited. The pressure may be, for example, 0.12 MPa or more and 0.70 MPa or less, or 0.15 MPa or more and 0.50 MPa or less.

Then, heating the sealed container oxidizes the surfaces of the particle bodies to form the oxide phases. The holding temperature and the holding time during heating are not limited. The holding temperature may be, for example, 50° C. or more and 300° C. or less, or 90° C. or more and 180° C. or less. The holding time may be, for example, 0.5 minutes or more and 300 minutes or less.

The higher the holding temperature, the larger the T1 tends to be. The higher the pressure inside the sealed container, the larger the T2 tends to be.

The higher the holding temperature, the higher the Co/a and the lower the P/a tend to be. The longer the holding time, the lower the Co/a and the higher the P/a tend to be.

Any method of measuring the thicknesses T1 and T2 of the oxide phases may be used. For example, first, a backscattered electron image of a cross-section of the magnetic core may be observed using a TEM or a SEM, and formation of the oxide phases on the particle surfaces may be confirmed using EDS. Then, from the backscattered electron image, the thicknesses of the oxide phases may be visually calculated. Alternatively, measurement points passing through the oxide phases may be determined and a line analysis may be carried out using EDS, for calculation using the results of the line analysis.

Any method of measuring Co/a and P/a of the oxide phases may be used. For example, measurement points passing through the oxide phases may be determined and a line analysis may be carried out using EDS, for calculation using the results of the line analysis.

The number of the specific particles for which T1, T2, Co/a, and P/a are measured with a SEM or EDS is not limited. The parameters are measured using a sufficient number of the specific particles for highly accurate calculation of the parameters.

For example, the thicknesses of the oxide phases of at least fifty specific particles and their composition may be measured in both the surface portion and the central portion of the magnetic core to calculate the parameters.

For example, in a situation where the magnetic core has high uniformity, the thickness of the oxide phase of one specific particle in the surface portion may be deemed to be T1. In a situation where the magnetic core has high uniformity, the thickness of the oxide phase of one specific particle in the central portion may be deemed to be T2. In a situation where the magnetic core has high uniformity, Co/a and P/a may be calculated from the composition of the oxide phase of one specific particle in the surface portion.

The magnetic core may be used for any purpose. The magnetic core can be suitably used as, for example, a magnetic core of an inductor.

Moreover, the above magnetic core or a magnetic component including the above magnetic core can be suitably included in an electronic device.

In particular, because the above magnetic core easily has high withstand voltage properties while maintaining suitable relative permeability, the magnetic core is suitably used in fields in need of smaller size or smaller height. The magnetic core can be suitably included in, for example, magnetic components (e.g., an inductor, a transformer, and a choke coil) or electronic devices including those magnetic components.

### Second Embodiment

Hereinafter, a magnetic core according to a second embodiment of the present disclosure is described with reference to the drawings. The second embodiment is similar to the first embodiment unless otherwise specified. What applies to the specific particles 11 of the first embodiment applies to specific particles 111 of the second embodiment unless otherwise specified. What applies to the oxide phases 11a of the first embodiment applies to oxide phases 111a of the second embodiment. What applies to the particle bodies 11b of the first embodiment applies to particle bodies 111b of the second embodiment.

In the magnetic core according to the present embodiment, spaces between soft magnetic metal particles may be filled with resin.

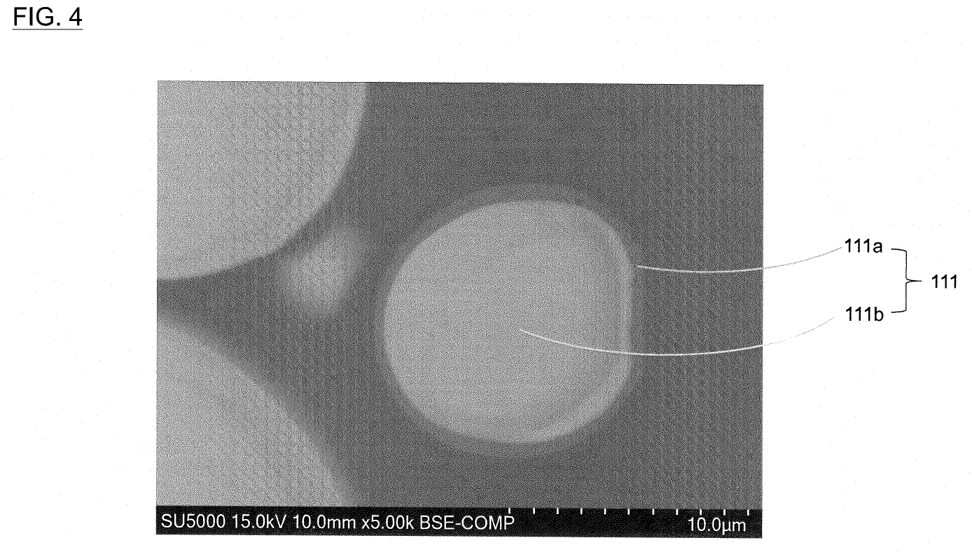

The magnetic core according to the present embodiment includes soft magnetic metal particles 111 (which may hereinafter be referred to as specific particles 111) each including an oxide phase 111a at a surface of the particle as shown in FIG. 4. In other words, each of the specific particles 111 includes a particle body 111b and the oxide phase 111a covering the particle body 111b.

The oxide phases 111a of the specific particles 111 may have any thickness. The oxide phases 111a of the specific particles 111 may have an average thickness of, for example, 0.025 μm or more. It may be that the soft magnetic metal particles whose oxide phases 111a have an average thickness of less than 0.025 μm are not deemed to be the specific particles 111.

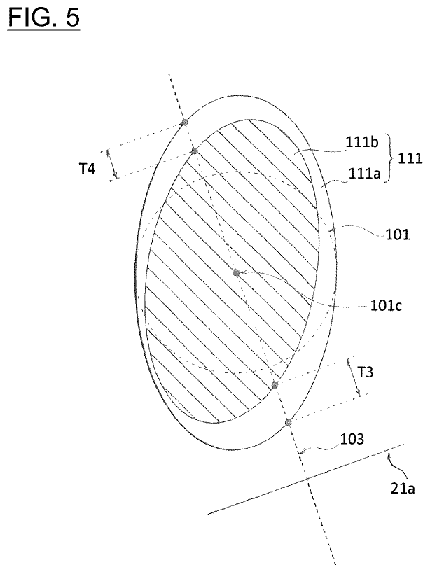

FIG. 5 is a schematic view of a cross-section of one specific particle 111. Hereinafter, methods of determining T3, T4, and T4/T3 of the specific particle 111 shown in FIG. 5 are described.

As shown in FIG. 5, an inscribed circle 101 touching a surface of the specific particle 111 (surface of the oxide phase 111a) is determined, and at the same time, a center 101c of the inscribed circle 101 is determined. This center 101c of the inscribed circle 101 is defined as the center 101c of the specific particle 111. This inscribed circle 101 is an incircle with a maximum possible diameter.

Then, a straight line containing the center 101c of the specific particle 111 is drawn. The straight line is 360° rotatable. As shown in FIG. 5, among freely drawable straight lines containing the center 101c of the specific particle 111, a straight line containing a maximum-thickness portion of the oxide phase 111a is defined as a specific straight line 103. The maximum-thickness portion is a portion where the length of the oxide phase 111a along the straight line is maximized. As shown in FIG. 5, the maximum-thickness portion has a length T3.

A portion of the oxide phase opposite the maximum-thickness portion relative to the center 101c along the specific straight line 103 is defined as an opposite maximum-thickness portion. As shown in FIG. 5, the opposite maximum-thickness portion has a length T4. The specific particle 111 may include no opposite maximum-thickness portion. In a situation where no oxide phase is observable using a TEM or a SEM, T4 is deemed to be T4=0.

Using the above T3 and T4, T4/T3 can be calculated. The magnetic core according to the present embodiment includes the specific particles 111 satisfying 0<T4/T3≤0.98. The magnetic core may include the specific particles 111 satisfying 0<T4/T3≤0.90. In the magnetic core according to the present embodiment, the specific particles 111 included in a surface portion 3 (described later) may satisfy 0<T4/T3≤0.98.

Average T4/T3, which is calculated by averaging calculation results of T4/T3 of all specific particles 111 included in the magnetic core, may be 0 or more and 0.98 or less or may be 0 or more and 0.90 or less. The average T4/T3 may be 0.09 or more and 0.98 or less or may be 0.09 or more and 0.90 or less.

The larger the T4/T3, the lower the relative permeability and the better the withstand voltage tend to be.

T3 is not limited. T3 may be, for example, 0.005 μm or more and 10.550 μm or less. T4 is not limited. T4 may be, for example, 0 μm or more and 10.339 μm or less.

The larger the T3, the lower the relative permeability and the better the withstand voltage tend to be. The larger the T4, the lower the relative permeability and the better the withstand voltage tend to be.

The specific particles 111 satisfying 0<T4/T3≤0.98 in a cross-section of the magnetic core may account for any percentage. In a cross-section of the magnetic core, the specific particles 111 satisfying 0<T4/T3≤0.98 in the surface portion 3 may account for a total area percentage of, for example, 1% or more and 85% or less of the area of the surface portion 3.

In a situation where an outermost surface of the magnetic core closest to the specific particle 111 is defined as a specific surface 21a, the maximum-thickness portion may be closer to the specific surface 21a than the opposite maximum-thickness portion is, as shown in FIG. 5.

Out of all specific particles 111 included in the magnetic core, the percentage of the specific particles whose maximum-thickness portion is closer to the specific surface 21a than the opposite maximum-thickness portion is may be 50% or more in terms of the number of particles.

The oxide phase 111a may have a crack. The crack may, for example, continue from the surface of the oxide phase 111a to a surface of the particle body 111b or end somewhere inside the oxide phase 111a.

The specific particle 111 may have any particle size. The particle size may be, for example, 0.1 μm or more and 100 μm or less in terms of a circle equivalent diameter in a cross-section of the magnetic core. All the specific particles 111 included in the magnetic core may have any average particle size. The average particle size may be, for example, 0.1 μm or more and 100 μm or less in terms of a circle equivalent diameter in a cross-section of the magnetic core. Note that the above average particle size is in terms of the number of particles.

A circle equivalent diameter of a specific particle 111 is a diameter of a circle having the same cross-sectional area as that of the specific particle 111.

Unlike the magnetic core according to the first embodiment, the magnetic core according to the present embodiment may include a surface portion 3 at a distance of 50 μm or less from the outermost surface and a central portion 4 at a distance of more than 50 μm from the outermost surface.

The magnetic core according to the present embodiment may include the specific particles 111 at least in the surface portion 3.

The magnetic core according to the present embodiment may satisfy T5≥0.050, T6≤0.50, and T5>T6, where T5 [μm] denotes the average thickness of the oxide phases of the specific particles 111 in the surface portion 3 and T6 [μm] denotes the average thickness of the oxide phases of the specific particles 111 in the central portion.

There is no upper limit of T5. The upper limit of T5 may be, for example, 10.0 or less or 5.0 or less. More specifically, 0.050≤T5≤10.0 may be satisfied, or 0.20≤T5≤5.0 may be satisfied. There is no lower limit of T6. The lower limit of T6 may be, for example, 0.000 or more. More specifically, 0.000≤T6≤0.50 may be satisfied.

T5−T6≥0.001 may be satisfied. T5−T6≥0.01 may be satisfied.

The average thickness T5 of the oxide phases 111a of the specific particles 111 in the surface portion 3 is calculated by averaging the average thicknesses of the oxide phases of all the specific particles 111 in the surface portion 3. The average thickness T6 of the oxide phases 111a of the specific particles 111 in the central portion 4 is calculated by averaging the average thicknesses of the oxide phases 111a of all the specific particles 111 in the central portion 4.

In a situation where the specific particles 111 are located on a boundary line between the surface portion 3 and the central portion 4, those specific particles 111 are deemed to be those included in the surface portion 3.

That is, in the magnetic core according to the present embodiment, the surface portion 3 may include the soft magnetic metal particles including thicker oxide phases than those of the central portion 4. This easily enables the magnetic core to have improved withstand voltage while maintaining suitable relative permeability.

In a situation where the surface portion 3 includes no specific particles 111, T5 is deemed to be T5=0.000. In a situation where the central portion includes no specific particles 111, T6 is deemed to be T6=0.000.

Co/α may be 0.10 or more and 1.00 or less or may be 0.18 or more and 0.70 or less in terms of atomicity.

A method of manufacturing the magnetic core according to the second embodiment is similar to that of the first embodiment except for the following.

To the magnetic core manufactured using a method similar to that of the first embodiment, an oxide phase formation treatment is performed. Through the oxide phase formation treatment, surfaces of the particle bodies included in the magnetic core are oxidized to form the oxide phases. Because the soft magnetic metal particles close to a surface of the magnetic core are more easily provided with thicker oxide phases, T5 easily becomes larger than T6.

Described below is a method of performing the oxide phase formation treatment.

First, the magnetic core and water are sealed in a metal sealed container. The amount of water (sealed amount) is not limited. The amount may be, for example, 0.1 parts by mass or more and 40.0 parts by mass or less, or 0.5 parts by mass or more and 30.0 parts by mass or less, with respect to 100 parts by mass magnetic core.

The holding temperature and the holding time during heating of the sealed container are not limited. The holding temperature may be, for example, 50° C. or more and 250° C. or less, or 90° C. or more and 200° C. or less. The holding time may be, for example, 0.5 minutes or more and 300 minutes or less.

The higher the holding temperature, the larger the T3 and T4 tend to be. The larger the amount of water, the larger the T4/T3 tends to be.

The higher the holding temperature, the larger the T5 tends to be. The higher the pressure inside the sealed container, the larger the T6 tends to be.

Any method of measuring the thicknesses T3 and T4 of the oxide phases and calculating T4/T3 may be used. For example, first, a backscattered electron image of a cross-section of the magnetic core may be observed using a TEM or a SEM, and formation of the oxide phases on the particle surfaces may be confirmed using EDS. Then, from the backscattered electron image, the thicknesses T3 and T4 of the oxide phases may be visually calculated, and T4/T3 may be calculated. Alternatively, measurement points passing through the oxide phases may be determined and a line analysis may be carried out using EDS, for calculation of T3 and T4 using the results of the line analysis and calculation of T4/T3.

The number of the specific particles whose T4/T3 is measured with a SEM or EDS for calculating average T4/T3 of the entire magnetic core is not limited. T4/T3 is measured using a sufficient number of the specific particles for highly accurate calculation of T4/T3. For example, in a situation where the magnetic core has high uniformity, T4/T3 of one specific particle may be deemed to be the average T4/T3 of the entire magnetic core.

Any method of measuring the thicknesses T5 and T6 of the oxide phases may be used. For example, first, a backscattered electron image of a cross-section of the magnetic core may be observed using a SEM, and formation of the oxide phases on the particle surfaces may be confirmed using EDS. Then, from the backscattered electron image, the thicknesses of the oxide phases may be visually calculated. Alternatively, measurement points passing through the oxide phases may be determined and a line analysis may be carried out using EDS, for calculation using the results of the line analysis.

The number of the specific particles for which T5 and T6 are measured with a SEM or EDS is not limited. T5 and T6 are measured using a sufficient number of the specific particles for highly accurate calculation of T5 and T6. For example, in a situation where the magnetic core has high uniformity, the thickness of the oxide phase of one specific particle in the surface portion may be deemed to be T5. In a situation where the magnetic core has high uniformity, the thickness of the oxide phase of one specific particle in the central portion may be deemed to be T6.

### EXAMPLES

Hereinafter, the present disclosure is specifically described based on examples.

### (Experiment 1)

As a master alloy, pure metal Fe was prepared. Pure metal Fe was heated and melted to provide a metal in a molten state (molten metal) having a temperature of 1600° C. Then, using a gas atomization method, a soft magnetic metal powder composed of pure metal Fe was manufactured. Specifically, at the time when the molten master alloy was discharged from a dripping molten metal discharge port to a cooling portion (cooling water) of a chamber, a high-pressure gas was sprayed to the discharged dripping molten metal. The pressure of the high-pressure gas was 5 MPa. The spray amount of the molten metal was 6 kg/min. Sieve classification was carried out so that the soft magnetic metal powder eventually obtained (pure iron powder in Experiment 1) had an average particle size of 25 μm.

It was confirmed, using an ICP analysis, that the composition of the master alloy and the composition of the soft magnetic metal powder approximately matched. The soft magnetic metal powder underwent an X-ray diffraction measurement to calculate the amorphous ratio X using the method described earlier. When the amorphous ratio X was 85% or more, the powder was deemed to have an amorphous structure. When the amorphous ratio X was less than 85% and the average crystallite size was 100 nm or less, the powder was deemed to have a nanocrystalline structure. When the amorphous ratio X was less than 85% and the average crystallite size exceeded 100 nm, the powder was deemed to have a crystalline structure. In Experiment 1, it was confirmed that the soft magnetic metal powder had a crystalline structure in all samples. The average particle size of the soft magnetic metal powder was checked using a SEM and was calculated.

Then, the soft magnetic metal powder (pure iron powder) and an epoxy resin were kneaded to provide a resin compound. The amount of the epoxy resin in the resin compound (resin amount) was 3 parts by mass with respect to 100 parts by mass soft magnetic metal powder.

Then, a mold was filled with the resin compound, and pressure was applied thereto, to provide a pressed body having a toroidal shape. The pressure applied at this time was controlled so that a magnetic core had a relative permeability (μ) of 30. The resultant pressed body was heat treated at 180° C. for 60 minutes to harden the epoxy resin, providing the magnetic core having a toroidal shape. The magnetic core had an outside diameter of 11 mm, an inside diameter of 6.5 mm, and a thickness of 2.5 mm.

Then, an oxide phase formation treatment was performed to the magnetic core having the toroidal shape except for Sample No. 1. First, the magnetic core and water were sealed in a metal sealed container. Then, the sealed container was once decompressed and had pressure applied thereto using a nitrogen gas. The sealed container was then heated. Table 1 shows the heating temperature and the pressure inside the sealed container. The amount of water (sealed amount) was 15 parts by mass with respect to 100 parts by mass magnetic core. The sealed container was held at a temperature shown in Table 1 for 60 minutes.

Another mold was filled with the resin compound, and pressure was applied thereto, to provide a pressed body having a rectangular parallelepiped shape. The pressure and heat treatment conditions were the same as those of the above magnetic core having the toroidal shape. The resultant magnetic core had a square bottom surface measuring 4.0 mm×4.0 mm and had a height of 1.0 mm.

Then, the oxide phase formation treatment was performed to the magnetic core having the rectangular parallelepiped shape except for Sample No. 1. Conditions of the oxide phase formation treatment were the same as those of the above magnetic core having the toroidal shape.

### (Average Thicknesses of Oxide Phases)

A cross-section of the resultant magnetic core having the toroidal shape was observed. T1 and T2 were measured. First, the cross-section of the magnetic core was observed with a SEM. At this time, the magnification was set low. Specifically, the magnification was set lower than that for measuring the thicknesses of oxide phases (described later). Through observation, whether an identified specific particle was included in a surface portion or a central portion of the magnetic core was checked. In Experiments 1 to 8, the surface portion meant that of the first embodiment; the central portion meant that of the first embodiment; and the specific particle meant that of the first embodiment.

Then, to measure the thickness of the oxide phase of the identified specific particle, the magnification and the location of the field of view were appropriately controlled so that the specific particle in its entirety was observable. The magnification was appropriately controlled within a range of ×1000 to ×50000.

Identification of the specific particle and measurement of the oxide phase were repeated. The thicknesses of the oxide phases of at least fifty specific particles included in the surface portion of the magnetic core were measured and averaged to calculate T1. The thicknesses of the oxide phases of at least fifty specific particles included in the central portion of the magnetic core were measured and averaged to calculate T2.

In Sample No. 1, in which the oxide phase formation treatment was not performed, no specific particles were included in the surface portion of the magnetic core. As described above, in a situation where no specific particles were included in the surface portion of the magnetic core, T1 was deemed to be 0.000.

In a situation where at least fifty specific particles were not identified in the surface portion, T1 was calculated from the thicknesses of the oxide phases of all specific particles identified in the surface portion. In a situation where at least fifty specific particles were not identified in the central portion, T2 was calculated from the thicknesses of the oxide phases of all specific particles identified in the central portion. That is, T1 was calculated from the thickness of the oxide phase of at least one specific particle in the surface portion, and T2 was calculated from the thickness of the oxide phase of at least one specific particle in the central portion.

In Sample No. 1, in which the oxide phase formation treatment was not performed; Sample Nos. 2 to 9, in which the pressure inside the sealed container was 0.15 MPa or less; and Sample No. 10, in which both the temperature and the pressure during the oxide phase formation treatment were low, no specific particles were included in the central portion of the magnetic core. As described above, in a situation where no specific particles were included in the central portion of the magnetic core, T2 was deemed to be 0.000.

### (Relative Permeability)

Relative permeability of the resultant magnetic core having the toroidal shape was measured. First, around the magnetic core having the toroidal shape, a polyurethane wire (UEW wire) was wound. Using an LCR meter (4284A manufactured by Agilent Technologies), relative permeability of the magnetic core was measured at a measurement frequency of 1 MHz. In Table 1, relative permeability is rounded off to one decimal place. Thus, despite relative permeability values shown in Table 1 being the same, rates of decrease in relative permeability may differ.

For each sample, the rate of decrease in relative permeability relative to that of a Comparative Example carried out under the same conditions except that the oxide phase formation treatment was not performed (Sample No. 1 in Experiment 1) was calculated. Each table shows the results. Relative permeability was deemed good when the rate of decrease in relative permeability was 15.0% or less or was deemed better when the rate of decrease was 10.0% or less.

### (Withstand Voltage)

Withstand voltage of the resultant magnetic core having the rectangular parallelepiped shape was measured. First, one of two square surfaces, measuring 4.0 mm×4.0 mm, of the magnetic core having the rectangular parallelepiped shape was selected. Then, the selected surface was provided with terminal electrodes having a width of 1.3 mm at both ends. The distance between the terminal electrodes was 1.4 mm.

Then, a voltage was applied between the terminal electrodes. The voltage at which a current of 2 mA flowed was measured as withstand voltage. In Table 1, withstand voltage is rounded off to the nearest whole number. Thus, despite withstand voltages shown in Table 1 being the same, rates of increase in withstand voltage may differ.

For each sample, the rate of increase in withstand voltage relative to that of a Comparative Example carried out under the same conditions except that the oxide phase formation treatment was not performed (Sample No. 1 in Experiment 1) was calculated. Each table shows the results. Withstand voltage was deemed good when the rate of increase in withstand voltage was 10.0% or more or was deemed better when the rate of increase was 20.0% or more.

TABLE 1

| | | | | | | | Rate of | | Rate of |
|---|---|---|---|---|---|---|---|---|---|
| | | Oxide phase | | | | | decrease in | | increase in |
| | | formation treatment | | Oxide phase | | | relative | Withstand | withstand |
| Sample | Example/ | Temperature | Pressure | T1 | T2 | Relative | permeability | voltage | voltage |
| No. | Comparative Example | (° C.) | (MPa) | (μm) | (μm) | permeability | (%) | (V) | (%) |
| 1 | Comparative Example | N/A | | 0.000 | 0.000 | 30.0 | — | 200 | — |
| 2 | Comparative Example | 200 | 0.11 | 0.025 | 0.000 | 30.0 | 0.0 | 200 | 0.0 |
| 3 | Example | 90 | 0.15 | 0.050 | 0.000 | 29.9 | 0.2 | 220 | 10.0 |
| 4 | Example | 100 | 0.15 | 0.202 | 0.000 | 29.9 | 0.5 | 280 | 40.0 |
| 5 | Example | 120 | 0.15 | 0.497 | 0.000 | 29.6 | 1.2 | 320 | 60.0 |
| 6 | Example | 130 | 0.15 | 1.012 | 0.000 | 29.3 | 2.3 | 340 | 70.0 |
| 7 | Example | 150 | 0.15 | 2.007 | 0.000 | 28.8 | 4.0 | 360 | 80.0 |
| 8 | Example | 180 | 0.15 | 4.985 | 0.000 | 27.6 | 8.0 | 390 | 95.0 |
| 9 | Example | 200 | 0.15 | 10.011 | 0.000 | 26.4 | 11.9 | 440 | 120.0 |
| 10 | Example | 90 | 0.20 | 0.051 | 0.000 | 29.9 | 0.2 | 220 | 10.2 |
| 11 | Example | 100 | 0.20 | 0.200 | 0.032 | 29.8 | 0.6 | 280 | 40.1 |
| 12 | Example | 120 | 0.20 | 0.501 | 0.041 | 29.6 | 1.3 | 321 | 60.3 |
| 13 | Example | 130 | 0.20 | 0.996 | 0.053 | 29.3 | 2.4 | 341 | 70.5 |
| 14 | Example | 150 | 0.20 | 1.989 | 0.086 | 28.8 | 4.1 | 361 | 80.6 |
| 15 | Example | 180 | 0.20 | 4.990 | 0.108 | 27.6 | 8.1 | 392 | 96.0 |
| 16 | Example | 200 | 0.20 | 9.998 | 0.125 | 26.2 | 12.7 | 444 | 122.0 |
| 17 | Example | 90 | 0.30 | 0.051 | 0.038 | 29.9 | 0.3 | 221 | 10.4 |
| 18 | Example | 100 | 0.30 | 0.205 | 0.056 | 29.8 | 0.7 | 281 | 40.4 |
| 19 | Example | 120 | 0.30 | 0.496 | 0.083 | 29.6 | 1.4 | 321 | 60.6 |
| 20 | Example | 130 | 0.30 | 1.009 | 0.159 | 29.2 | 2.6 | 342 | 70.8 |
| 21 | Example | 150 | 0.30 | 2.012 | 0.258 | 28.6 | 4.6 | 362 | 81.0 |
| 22 | Example | 180 | 0.30 | 4.997 | 0.324 | 27.5 | 8.4 | 394 | 96.9 |
| 23 | Example | 200 | 0.30 | 9.989 | 0.480 | 25.6 | 14.8 | 447 | 123.4 |
| 24 | Example | 90 | 0.50 | 0.053 | 0.050 | 29.9 | 0.4 | 222 | 11.2 |
| 25 | Example | 100 | 0.50 | 0.202 | 0.080 | 29.8 | 0.8 | 283 | 41.4 |
| 26 | Example | 120 | 0.50 | 0.507 | 0.125 | 29.6 | 1.5 | 324 | 62.1 |
| 27 | Example | 130 | 0.50 | 0.992 | 0.264 | 29.1 | 2.9 | 345 | 72.5 |
| 28 | Example | 150 | 0.50 | 2.010 | 0.428 | 28.5 | 5.0 | 366 | 83.0 |
| 29 | Example | 180 | 0.50 | 5.000 | 0.500 | 27.2 | 9.2 | 399 | 99.7 |
| 30 | Comparative Example | 200 | 0.50 | 10.021 | 0.568 | 22.7 | 24.3 | 451 | 125.4 |
| 31 | Example | 90 | 0.70 | 0.053 | 0.051 | 29.9 | 0.4 | 223 | 11.7 |
| 32 | Example | 100 | 0.70 | 0.202 | 0.201 | 29.7 | 1.0 | 286 | 43.0 |
| 33 | Example | 120 | 0.70 | 0.507 | 0.492 | 29.3 | 2.4 | 330 | 65.0 |
| 34 | Comparative Example | 130 | 0.70 | 0.992 | 0.970 | 23.4 | 22.1 | 350 | 75.0 |

According to Table 1, in Sample Nos. 3 to 29 and 31 to 33, in which the oxide phase formation treatment was performed under suitable conditions, T1 and T2 were within predetermined ranges. Consequently, it was possible to improve withstand voltage while a decrease in relative permeability was mitigated compared to Sample No. 1, which was carried out under the same conditions except that the oxide phase formation treatment was not performed.

With regard to specific particles included in a magnetic core of all Examples of Experiments 2 to 8 described later, it was confirmed that the composition of oxide phases and the composition of particle bodies matched 50% or more in terms of atomicity without oxygen and carbon being taken into account.

In all Examples of Experiments 2 to 8 described later, it was confirmed that, in a cross-section of the magnetic core, the specific particles accounted for an area percentage of 1% or more and 85% or less of a surface portion.

In Sample No. 2, in which the pressure of the oxide phase formation treatment was too low, T1 was too small. Consequently, neither relative permeability nor withstand voltage changed from those of Sample No. 1.

In Sample No. 30, in which the temperature and the pressure of the oxide phase formation treatment were high, T2 was too large. Consequently, relative permeability was significantly lower than that of Sample No. 1, which was carried out under the same conditions except that the oxide phase formation treatment was not performed.

In Sample No. 34, in which the pressure of the oxide phase formation treatment was high, T2 was too large. Consequently, relative permeability was significantly lower than that of Sample No. 1, which was carried out under the same conditions except that the oxide phase formation treatment was not performed.

### (Experiment 2)

With the composition and the microstructure of the soft magnetic metal powder being changed from those of Sample Nos. 1, 14, and 15, Experiment 2 was conducted.

The composition of the soft magnetic metal powder was changed by changing the composition of the master alloy. The temperature of the molten metal was appropriately controlled within a range of 1200° C. to 1600° C. according to the composition of the molten metal.

Tables 2A to 2C show the composition of the soft magnetic metal powder and the results. The composition is shown in terms of atomicity. Note that, in Experiments 2 to 8, descriptions of relative permeability and withstand voltage are omitted. Only the rate of decrease in relative permeability and the rate of increase in withstand voltage relative to those of a sample that had the same composition but did not undergo the oxide phase formation treatment are shown.

Using XRD, it was confirmed that the powder had a crystalline structure in all of Sample Nos. 35 to 52, 59 to 64, and 77 to 91.

Using XRD, it was confirmed that the powder had an amorphous structure in all of Sample Nos. 53 to 55, 65 to 70, 92 to 97, and 104 to 109.

In Sample Nos. 56 to 58, 71 to 76, and 98 to 103, the powder was heat treated after being prepared using the gas atomization method to deposit nanocrystals with a crystallite size of 30 nm or less. The heat treatment was performed specifically at 400° C. to 650° C. for 10 to 60 minutes. Using XRD, it was confirmed that the powder had a nanocrystalline structure in all of Sample Nos. 56 to 58, 71 to 76, and 98 to 103.

TABLE 2A

| | | | | | | | | Rate of | Rate of |
|---|---|---|---|---|---|---|---|---|---|
| | | | | Oxide phase | | | | decrease in | increase in |
| | Example/ | Powder | | formation treatment | | Oxide phase | | relative | withstand |
| Sample | Comparative | Composition | | Temperature | Pressure | T1 | T2 | permeability | voltage |
| No. | Example | (atomic ratio) | Microstructure | (° C.) | (MPa) | (μm) | (μm) | (%) | (%) |
| 1 | Comparative | 100.0Fe | Crystalline | N/A | | 0.000 | 0.000 | — | — |
| | Example | | | | | | | | |
| 14 | Example | 100.0Fe | Crystalline | 150 | 0.20 | 1.989 | 0.086 | 4.1 | 80.6 |
| 15 | Example | 100.0Fe | Crystalline | 180 | 0.20 | 4.990 | 0.108 | 8.1 | 96.0 |
| 35 | Comparative | 80.0Fe—20.0Ni | Crystalline | N/A | | 0.000 | 0.000 | — | — |
| | Example | | | | | | | | |
| 36 | Example | 80.0Fe—20.0Ni | Crystalline | 150 | 0.20 | 1.712 | 0.068 | 3.7 | 78.3 |
| 37 | Example | 80.0Fe—20.0Ni | Crystalline | 180 | 0.20 | 3.998 | 0.079 | 6.3 | 91.5 |
| 38 | Comparative | 50.0Fe—50.0Ni | Crystalline | N/A | | 0.000 | 0.000 | — | — |
| | Example | | | | | | | | |
| 39 | Example | 50.0Fe—50.0Ni | Crystalline | 150 | 0.20 | 0.982 | 0.039 | 2.1 | 69.3 |
| 40 | Example | 50.0Fe—50.0Ni | Crystalline | 180 | 0.20 | 2.495 | 0.048 | 5.0 | 84.0 |
| 41 | Comparative | 20.0Fe—80.0Ni | Crystalline | N/A | | 0.000 | 0.000 | — | — |
| | Example | | | | | | | | |
| 42 | Example | 20.0Fe—80.0Ni | Crystalline | 150 | 0.20 | 0.512 | 0.026 | 1.1 | 62.8 |
| 43 | Example | 20.0Fe—80.0Ni | Crystalline | 180 | 0.20 | 1.117 | 0.032 | 2.3 | 71.3 |
| 44 | Comparative | 100.0Ni | Crystalline | N/A | | 0.000 | 0.000 | — | — |
| | Example | | | | | | | | |
| 45 | Example | 100.0Ni | Crystalline | 150 | 0.20 | 0.058 | 0.000 | 0.6 | 14.8 |
| 46 | Example | 100.0Ni | Crystalline | 180 | 0.20 | 0.153 | 0.000 | 1.3 | 41.9 |
| 47 | Comparative | 90.0Fe—10.0Si | Crystalline | N/A | | 0.000 | 0.000 | — | — |
| | Example | | | | | | | | |
| 48 | Example | 90.0Fe—10.0Si | Crystalline | 150 | 0.20 | 1.983 | 0.079 | 3.9 | 80.3 |
| 49 | Example | 90.0Fe—10.0Si | Crystalline | 180 | 0.20 | 4.800 | 0.095 | 7.4 | 95.3 |
| 50 | Comparative | 89.4Fe—8.6Si—2.0Cr | Crystalline | N/A | | 0.000 | 0.000 | — | — |
| | Example | | | | | | | | |
| 51 | Example | 89.4Fe—8.6Si—2.0Cr | Crystalline | 150 | 0.20 | 1.978 | 0.078 | 4.0 | 80.5 |
| 52 | Example | 89.4Fe—8.6Si—2.0Cr | Crystalline | 180 | 0.20 | 4.700 | 0.096 | 7.3 | 94.2 |
| 53 | Comparative | 75.0Fe—10.0Si—15.0B | Amorphous | N/A | | 0.000 | 0.000 | — | — |
| | Example | | | | | | | | |
| 54 | Example | 75.0Fe—10.0Si—15.0B | Amorphous | 150 | 0.20 | 1.624 | 0.065 | 3.2 | 77.7 |
| 55 | Example | 75.0Fe—10.0Si—15.0B | Amorphous | 180 | 0.20 | 3.800 | 0.078 | 6.1 | 90.3 |
| 56 | Comparative | 73.5Fe—13.5Si—9.0B—3.0Nb—1.0Cu | Nanocrystalline | N/A | | 0.000 | 0.000 | — | — |
| | Example | | | | | | | | |
| 57 | Example | 73.5Fe—13.5Si—9.0B—3.0Nb—1.0Cu | Nanocrystalline | 150 | 0.20 | 1.579 | 0.062 | 3.3 | 74.9 |
| 58 | Example | 73.5Fe—13.5Si—9.0B—3.0Nb—1.0Cu | Nanocrystalline | 180 | 0.20 | 3.780 | 0.076 | 6.0 | 87.8 |

TABLE 2B

| | | | | Oxide phase | | | | | |
|---|---|---|---|---|---|---|---|---|---|
| | | | | formation | | | | Rate of | Rate of |
| | | | | treatment | | | | decrease in | increase in |
| | Example/ | Powder | | Temper- | Pres- | Oxide phase | | relative | withstand |
| Sample | Comparative | Composition | | ature | sure | T1 | T2 | permeability | voltage |
| No. | Example | (atomic ratio) | Microstructure | (° C.) | (MPa) | (μm) | (μm) | (%) | (%) |
| 59 | Comparative | 73.7Fe—16.4Si—9.9Al | Crystalline | N/A | | 0.000 | 0.000 | — | — |
| | Example | | | | | | | | |
| 60 | Example | 73.7Fe—16.4Si—9.9Al | Crystalline | 150 | 0.20 | 1.510 | 0.060 | 3.1 | 80.0 |
| 61 | Example | 73.7Fe—16.4Si—9.9Al | Crystalline | 180 | 0.20 | 3.924 | 0.078 | 6.1 | 93.0 |
| 62 | Comparative | 59.0Fe—16.4Si—9.9Al—14.7Ni | Crystalline | N/A | | 0.000 | 0.000 | — | — |
| | Example | | | | | | | | |
| 63 | Example | 59.0Fe—16.4Si—9.9Al—14.7Ni | Crystalline | 150 | 0.20 | 1.252 | 0.051 | 2.5 | 78.0 |
| 64 | Example | 59.0Fe—16.4Si—9.9Al—14.7Ni | Crystalline | 180 | 0.20 | 2.987 | 0.059 | 5.0 | 88.0 |
| 65 | Comparative | 81.6Fe—13.4B—3.4Si—1.6C | Amorphous | N/A | | 0.000 | 0.000 | — | — |
| | Example | | | | | | | | |
| 66 | Example | 81.6Fe—13.4B—3.4Si—1.6C | Amorphous | 150 | 0.20 | 1.867 | 0.075 | 3.7 | 83.4 |
| 67 | Example | 81.6Fe—13.4B—3.4Si—1.6C | Amorphous | 180 | 0.20 | 4.013 | 0.080 | 6.4 | 95.0 |
| 68 | Comparative | 72.7Fe—10.8B—11.6Si—2.7C—2.2Cr | Amorphous | N/A | | 0.000 | 0.000 | — | — |
| | Example | | | | | | | | |
| 69 | Example | 72.7Fe—10.8B—11.6Si—2.7C—2.2Cr | Amorphous | 150 | 0.20 | 1.472 | 0.059 | 3.0 | 80.5 |
| 70 | Example | 72.7Fe—10.8B—11.6Si—2.7C—2.2Cr | Amorphous | 180 | 0.20 | 3.759 | 0.075 | 5.9 | 94.5 |
| 71 | Comparative | 82.0Fe—11.0B—5.0P—1.0Si—1.0Cu | Nanocrystalline | N/A | | 0.000 | 0.000 | — | — |
| | Example | | | | | | | | |
| 72 | Example | 82.0Fe—11.0B—5.0P—1.0Si—1.0Cu | Nanocrystalline | 150 | 0.20 | 1.920 | 0.077 | 3.9 | 84.8 |
| 73 | Example | 82.0Fe—11.0B—5.0P—1.0Si—1.0Cu | Nanocrystalline | 180 | 0.20 | 4.143 | 0.083 | 6.8 | 98.5 |
| 74 | Comparative | 78.0Fe—9.0B—3.0P—3.0Si—6.0Nb—1.0Cr | Nanocrystalline | N/A | | 0.000 | 0.000 | — | — |
| | Example | | | | | | | | |
| 75 | Example | 78.0Fe—9.0B—3.0P—3.0Si—6.0Nb—1.0Cr | Nanocrystalline | 150 | 0.20 | 1.689 | 0.067 | 3.5 | 84.3 |
| 76 | Example | 78.0Fe—9.0B—3.0P—3.0Si—6.0Nb—1.0Cr | Nanocrystalline | 180 | 0.20 | 4.012 | 0.081 | 6.4 | 97.9 |

TABLE 2C

| | | | | Oxide phase | | | | | |
|---|---|---|---|---|---|---|---|---|---|
| | | | | formation | | | | Rate of | Rate of |
| | | | | treatment | | | | decrease in | increase in |
| | Example/ | Powder | | Temper- | Pres- | Oxide phase | | relative | withstand |
| Sample | Comparative | Composition | Micro- | ature | sure | T1 | T2 | permeability | voltage |
| No. | Example | (atomic ratio) | structure | (° C.) | (MPa) | (μm) | (μm) | (%) | (%) |
| 77 | Comparative | 50.0Fe—50.0Co | Crystalline | N/A | — | 0.000 | 0.000 | — | — |
| | Example | | | | | | | | |
| 78 | Example | 50.0Fe—50.0Co | Crystalline | 150 | 0.20 | 1.521 | 0.061 | 3.1 | 86.0 |
| 79 | Example | 50.0Fe—50.0Co | Crystalline | 180 | 0.20 | 4.328 | 0.087 | 6.3 | 102.4 |
| 80 | Comparative | 49.0Fe—49.0Co—2.0V | Crystalline | N/A | — | 0.000 | 0.000 | — | — |
| | Example | | | | | | | | |
| 81 | Example | 49.0Fe—49.0Co—2.0V | Crystalline | 150 | 0.20 | 1.482 | 0.059 | 3.0 | 86.2 |
| 82 | Example | 49.0Fe—49.0Co—2.0V | Crystalline | 180 | 0.20 | 4.297 | 0.086 | 6.2 | 103.5 |
| 83 | Comparative | 83.6Fe—4.4Co—12.0Si | Crystalline | N/A | — | 0.000 | 0.000 | — | — |
| | Example | | | | | | | | |
| 84 | Example | 83.6Fe—4.4Co—12.0Si | Crystalline | 150 | 0.20 | 1.296 | 0.052 | 2.6 | 87.0 |
| 85 | Example | 83.6Fe—4.4Co—12.0Si | Crystalline | 180 | 0.20 | 3.891 | 0.078 | 5.6 | 102.0 |
| 86 | Comparative | 36.9Fe—36.8Co—16.4Si—9.9Al | Crystalline | N/A | — | 0.000 | 0.000 | — | — |
| | Example | | | | | | | | |
| 87 | Example | 36.9Fe—36.8Co—16.4Si—9.9Al | Crystalline | 150 | 0.20 | 1.076 | 0.043 | 2.3 | 85.6 |
| 88 | Example | 36.9Fe—36.8Co—16.4Si—9.9Al | Crystalline | 180 | 0.20 | 3.200 | 0.064 | 5.0 | 98.0 |
| 89 | Comparative | 80.5Fe—9.0Co—8.5Si—2.0Cr | Crystalline | N/A | — | 0.000 | 0.000 | — | — |
| | Example | | | | | | | | |
| 90 | Example | 80.5Fe—9.0Co—8.5Si—2.0Cr | Crystalline | 150 | 0.20 | 1.210 | 0.048 | 2.5 | 85.0 |
| 91 | Example | 80.5Fe—9.0Co—8.5Si—2.0Cr | Crystalline | 180 | 0.20 | 3.800 | 0.076 | 5.5 | 100.0 |
| 92 | Comparative | 66.8Fe—16.7Co—11.0B—4.5P—1.0Si | Amorphous | N/A | — | 0.000 | 0.000 | — | — |
| | Example | | | | | | | | |
| 93 | Example | 66.8Fe—16.7Co—11.0B—4.5P—1.0Si | Amorphous | 150 | 0.20 | 1.167 | 0.046 | 2.4 | 85.0 |
| 94 | Example | 66.8Fe—16.7Co—11.0B—4.5P—1.0Si | Amorphous | 180 | 0.20 | 3.586 | 0.071 | 5.3 | 100.0 |
| 95 | Comparative | 57.4Fe—24.6Co—11.0B—3.0P—3.0Si—1.0Cr | Amorphous | N/A | — | 0.000 | 0.000 | — | — |
| | Example | | | | | | | | |
| 96 | Example | 57.4Fe—24.6Co—11.0B—3.0P—3.0Si—1.0Cr | Amorphous | 150 | 0.20 | 1.167 | 0.047 | 2.4 | 85.0 |
| 97 | Example | 57.4Fe—24.6Co—11.0B—3.0P—3.0Si—1.0Cr | Amorphous | 180 | 0.20 | 3.529 | 0.071 | 5.2 | 100.0 |
| 98 | Comparative | 62.4Fe—15.6Co—11.3B—5.0P—5.0Si—0.7Cu | Nano- | N/A | — | 0.000 | 0.000 | — | — |
| | Example | | crystalline | | | | | | |
| 99 | Example | 62.4Fe—15.6Co—11.3B—5.0P—5.0Si—0.7Cu | Nano- | 150 | 0.20 | 1.176 | 0.047 | 2.4 | 85.0 |
| | | | crystalline | | | | | | |
| 100 | Example | 62.4Fe—15.6Co—11.3B—5.0P—5.0Si—0.7Cu | Nano- | 180 | 0.20 | 3.243 | 0.065 | 5.1 | 100.0 |
| | | | crystalline | | | | | | |
| 101 | Comparative | 55.3Fe—23.7Co—11.0B—2.0P—3.0Si—5.0Nb | Nano- | N/A | — | 0.000 | 0.000 | — | — |
| | Example | | crystalline | | | | | | |
| 102 | Example | 55.3Fe—23.7Co—11.0B—2.0P—3.0Si—5.0Nb | Nano- | 150 | 0.20 | 1.155 | 0.046 | 2.4 | 85.0 |
| | | | crystalline | | | | | | |
| 103 | Example | 55.3Fe—23.7Co—11.0B—2.0P—3.0Si—5.0Nb | Nano- | 180 | 0.20 | 3.421 | 0.069 | 5.1 | 100.0 |
| | | | crystalline | | | | | | |
| 104 | Comparative | 41.0Fe—41.0Co—11.0B—3.0P—3.0Si—1.0Cr | Amorphous | N/A | — | 0.000 | 0.000 | — | — |
| | Example | | | | | | | | |
| 105 | Example | 41.0Fe—41.0Co—11.0B—3.0P—3.0Si—1.0Cr | Amorphous | 150 | 0.20 | 1.155 | 0.046 | 2.4 | 85.0 |
| 106 | Example | 41.0Fe—41.0Co—11.0B—3.0P—3.0Si—1.0Cr | Amorphous | 180 | 0.20 | 3.502 | 0.070 | 5.2 | 100.0 |
| 107 | Comparative | 32.8Fe—49.2Co—11.0B—3.0P—3.0Si—1.0Cr | Amorphous | N/A | — | 0.000 | 0.000 | — | — |
| | Example | | | | | | | | |
| 108 | Example | 32.8Fe—49.2Co—11.0B—3.0P—3.0Si—1.0Cr | Amorphous | 150 | 0.20 | 1.138 | 0.045 | 2.4 | 85.0 |
| 109 | Example | 32.8Fe—49.2Co—11.0B—3.0P—3.0Si—1.0Cr | Amorphous | 180 | 0.20 | 3.481 | 0.068 | 5.2 | 100.0 |

According to Tables 2A to 2C, there was a similar tendency as in Experiment 1 despite the type and/or the microstructure of the powder being changed from those of Experiment 1.

### (Experiment 3)

The average particle size of the soft magnetic metal powder was changed from that of Sample Nos. 1, 14, and 15 of Experiment 1. Moreover, the treatment temperature of the oxide phase formation treatment was changed so that the smaller the average particle size of the soft magnetic metal powder, the smaller the T1 and T2. Other than that, Experiment 3 was conducted as in Experiment 1. Table 3 shows the results.

TABLE 3

| | | Powder | | | | | Rate of | Rate of |
|---|---|---|---|---|---|---|---|---|
| | | Average | Oxide phase | | | | decrease in | increase in |
| | | particle | formation treatment | | Oxide phase | | relative | withstand |
| Sample | Example/ | size | Temperature | Pressure | T1 | T2 | permeability | voltage |
| No. | Comparative Example | (μm) | (° C.) | (MPa) | (μm) | (μm) | (%) | (%) |
| 110 | Comparative Example | 1.0 | N/A | | 0.000 | 0.000 | — | — |
| 111 | Example | 1.0 | 90 | 0.20 | 0.052 | 0.025 | 2.4 | 20.0 |
| 112 | Example | 1.0 | 100 | 0.20 | 0.204 | 0.031 | 7.9 | 40.0 |
| 113 | Comparative Example | 3.0 | N/A | | 0.000 | 0.000 | — | — |
| 114 | Example | 3.0 | 120 | 0.20 | 0.497 | 0.040 | 6.5 | 60.0 |
| 115 | Example | 3.0 | 130 | 0.20 | 1.001 | 0.053 | 10.5 | 72.3 |
| 116 | Comparative Example | 5.0 | N/A | | 0.000 | 0.000 | — | — |
| 117 | Example | 5.0 | 130 | 0.20 | 1.010 | 0.053 | 7.9 | 74.0 |
| 118 | Example | 5.0 | 150 | 0.20 | 1.994 | 0.087 | 11.0 | 81.3 |
| 119 | Comparative Example | 10 | N/A | | 0.000 | 0.000 | — | — |
| 120 | Example | 10 | 130 | 0.20 | 0.989 | 0.053 | 5.0 | 77.2 |
| 121 | Example | 10 | 150 | 0.20 | 2.010 | 0.086 | 8.1 | 81.0 |
| 1 | Comparative Example | 25 | N/A | | 0.000 | 0.000 | — | — |
| 14 | Example | 25 | 150 | 0.20 | 1.989 | 0.086 | 4.1 | 80.6 |
| 15 | Example | 25 | 180 | 0.20 | 4.995 | 0.108 | 8.1 | 96.0 |
| 122 | Comparative Example | 50 | N/A | | 0.000 | 0.000 | — | — |
| 123 | Example | 50 | 150 | 0.20 | 2.012 | 0.087 | 2.0 | 85.9 |
| 124 | Example | 50 | 180 | 0.20 | 5.008 | 0.114 | 5.0 | 98.9 |

According to Table 3, there was a similar tendency as in Experiment 1 despite the average particle size of the powder, T1, and T2 being changed from those of Experiment 1.

### (Experiment 4)

A coating film formation treatment was performed to the soft magnetic metal powder of Sample Nos. 1, 14, and 15 using a mechanofusion system (AMS-Lab manufactured by HOSOKAWA MICRON CORPORATION) to form a P—Zn—Al—O based oxide glass coating film on surfaces of the soft magnetic metal powder. The coating film had a thickness of about 10 nm. Other than that, Sample Nos. 125 to 127 were carried out as in Experiment 1. Table 4 shows the results.

The type of the coating film of the soft magnetic metal powder was changed from that of Sample Nos. 125 to 127. Table 4 shows types of the coating film. Samples whose coating film was a P—Zn—Al—Na—O based oxide glass coating film, a P—Zn—Al—Ca—O based oxide glass coating film, a Bi—Zn—B—Si—O based oxide glass coating film, or a Ba—Zn—B—Si—Al—O based oxide glass coating film were carried out as in Sample Nos. 125 to 127. For samples whose coating film was a phosphate film, a phosphate treatment was appropriately performed to the soft magnetic metal powder of Sample Nos. 1, 14, and 15. For samples whose coating film was a SiO₂ film, a silane coupling treatment was appropriately performed to the soft magnetic metal powder of Sample Nos. 1, 14, and 15. Table 4 shows the results.

TABLE 4

| | | | | | | | Rate of | Rate of |
|---|---|---|---|---|---|---|---|---|
| | | | Oxide phase | | | | decrease in | increase in |
| | | | formation treatment | | Oxide phase | | relative | withstand |
| Sample | Example/ | Coating film | Temperature | Pressure | T1 | T2 | permeability | voltage |
| No. | Comparative Example | Composition | (° C.) | (MPa) | (μm) | (μm) | (%) | (%) |
| 1 | Comparative Example | N/A | N/A | — | 0.000 | 0.000 | — | — |
| 14 | Example | N/A | 150 | 0.20 | 1.989 | 0.086 | 4.1 | 80.6 |
| 15 | Example | N/A | 180 | 0.20 | 4.990 | 0.108 | 8.1 | 96.0 |
| 125 | Comparative Example | P—Zn—Al—O | N/A | — | 0.000 | 0.000 | — | — |
| 126 | Example | P—Zn—Al—O | 150 | 0.20 | 2.007 | 0.096 | 4.2 | 80.9 |
| 127 | Example | P—Zn—Al—O | 180 | 0.20 | 4.998 | 0.122 | 8.2 | 96.4 |
| 128 | Comparative Example | P—Zn—Al—Na—O | N/A | — | 0.000 | 0.000 | — | — |
| 129 | Example | P—Zn—Al—Na—O | 150 | 0.20 | 2.007 | 0.097 | 4.3 | 80.8 |
| 130 | Example | P—Zn—Al—Na—O | 180 | 0.20 | 4.999 | 0.120 | 8.2 | 96.4 |
| 131 | Comparative Example | P—Zn—Al—Ca—O | N/A | — | 0.000 | 0.000 | — | — |
| 132 | Example | P—Zn—Al—Ca—O | 150 | 0.20 | 2.013 | 0.095 | 4.2 | 80.8 |
| 133 | Example | P—Zn—Al—Ca—O | 180 | 0.20 | 4.997 | 0.125 | 8.3 | 96.4 |
| 134 | Comparative Example | Bi—Zn—B—Si—O | N/A | — | 0.000 | 0.000 | — | — |
| 135 | Example | Bi—Zn—B—Si—O | 150 | 0.20 | 2.008 | 0.099 | 4.2 | 80.9 |
| 136 | Example | Bi—Zn—B—Si—O | 180 | 0.20 | 4.998 | 0.122 | 8.3 | 96.3 |
| 137 | Comparative Example | Ba—Zn—B—Si—Al—O | N/A | — | 0.000 | 0.000 | — | — |
| 138 | Example | Ba—Zn—B—Si—Al—O | 150 | 0.20 | 2.003 | 0.098 | 4.3 | 80.8 |
| 139 | Example | Ba—Zn—B—Si—Al—O | 180 | 0.20 | 4.998 | 0.120 | 8.2 | 96.5 |
| 140 | Comparative Example | Phosphate film | N/A | — | 0.000 | 0.000 | — | — |
| 141 | Example | Phosphate film | 150 | 0.20 | 2.003 | 0.095 | 4.3 | 80.8 |
| 142 | Example | Phosphate film | 180 | 0.20 | 4.999 | 0.121 | 8.3 | 96.5 |
| 143 | Comparative Example | SiO₂ film | N/A | — | 0.000 | 0.000 | — | — |
| 144 | Example | SiO₂ film | 150 | 0.20 | 2.007 | 0.096 | 4.2 | 80.9 |
| 145 | Example | SiO₂ film | 180 | 0.20 | 4.998 | 0.122 | 8.3 | 96.5 |

According to Table 4, there was a similar tendency as in Experiment 1 despite the type of the coating film of the soft magnetic metal powder being changed.

Also, in each Example shown in Table 4, in the specific particles resulting from the oxide phase formation treatment to the soft magnetic metal powder with the coating film, no boundaries were confirmed between the coating film and the oxide phase formed with the oxide phase formation treatment.

### (Experiment 5)

The soft magnetic metal powder having an average particle size of 25 μm used in Experiment 1 was defined as a powder A. A soft magnetic metal powder that was prepared under the same conditions as those of the powder A except that the average particle size was 3.0 μm was defined as a powder B. A soft magnetic metal powder that was prepared under the same conditions as those of the powder A except that the average particle size was 0.8 μm was defined as a powder C. The powders A to C were mixed at a ratio shown in Table 5 to provide a mixed powder.

Experiment 5 was conducted as in Sample Nos. 1 and 14 of Experiment 1 except that the mixed powder was used. Table 5 shows the results.

TABLE 5

| | | Powder | | | | | | | | | | | Rate of | Rate of |
|---|---|---|---|---|---|---|---|---|---|---|---|---|---|---|
| | | | Average particle | | | Mix ratio | | | Oxide phase | | | | decrease in | increase in |
| | Example/ | | size (μm) | | | (mass %) | | | formation treatment | | Oxide phase | | relative | withstand |
| Sample | Comparative | Compo- | Pow- | Pow- | Pow- | Pow- | Pow- | Pow- | Temperature | Pressure | T1 | T2 | permeability | voltage |
| No. | Example | sition | der A | der B | der C | der A | der B | der C | (° C.) | (MPa) | (μm) | (μm) | (%) | (%) |
| 1 | Comparative | Fe | 25 | 3.0 | 0.8 | 100 | 0 | 0 | N/A | | 0.000 | 0.000 | — | — |
| | Example | | | | | | | | | | | | | |
| 14 | Example | Fe | 25 | 3.0 | 0.8 | 100 | 0 | 0 | 150 | 0.20 | 1.989 | 0.086 | 4.1 | 80.6 |
| 146 | Comparative | Fe | 25 | 3.0 | 0.8 | 90 | 5 | 5 | N/A | | 0.000 | 0.000 | — | — |
| | Example | | | | | | | | | | | | | |
| 147 | Example | Fe | 25 | 3.0 | 0.8 | 90 | 5 | 5 | 150 | 0.20 | 1.987 | 0.086 | 4.3 | 80.4 |
| 148 | Comparative | Fe | 25 | 3.0 | 0.8 | 80 | 10 | 10 | N/A | | 0.000 | 0.000 | — | — |
| | Example | | | | | | | | | | | | | |
| 149 | Example | Fe | 25 | 3.0 | 0.8 | 80 | 10 | 10 | 150 | 0.20 | 1.986 | 0.085 | 4.5 | 79.9 |
| 150 | Comparative | Fe | 25 | 3.0 | 0.8 | 50 | 25 | 25 | N/A | | 0.000 | 0.000 | — | — |
| | Example | | | | | | | | | | | | | |
| 151 | Example | Fe | 25 | 3.0 | 0.8 | 50 | 25 | 25 | 150 | 0.20 | 1.986 | 0.083 | 4.9 | 79.3 |
| 152 | Comparative | Fe | 25 | 3.0 | 0.8 | 30 | 35 | 35 | N/A | | 0.000 | 0.000 | — | — |
| | Example | | | | | | | | | | | | | |
| 153 | Example | Fe | 25 | 3.0 | 0.8 | 30 | 35 | 35 | 150 | 0.20 | 1.982 | 0.084 | 5.4 | 78.1 |

According to Table 5, there was a similar tendency as in Experiment 1 despite multiple types of powders with different average particle sizes being mixed.

### (Experiment 6)

Experiment 6 was conducted as in Sample Nos. 148 and 149 of Experiment 5 except that the composition of at least one of the powders A to C was changed to a composition shown in Table 6A. Note that the powder A of Sample Nos. 158, 159, 164, and 165; the powder B of Sample Nos. 170, 171, 176, and 177; and the powder C of Sample Nos. 182, 183, 188, and 189 were heat treated after being prepared using the gas atomization method to deposit nanocrystals with a crystallite size of 30 nm or less. The heat treatment was performed specifically at 400° C. to 650° C. for 10 to 60 minutes. Using XRD, it was confirmed that each powder had a microstructure shown in Table 6A. Tables 6A and 6B show the results.

TABLE 6A

| Sam- | | Powder | | |
|---|---|---|---|---|
| ple | Example/ | Powder A | | Powder B |
| No. | Comparative Example | Composition (atomic ratio) | Microstructure | Composition (atomic ratio) |
| 148 | Comparative Example | Fe | Crystalline | Fe |
| 149 | Example | Fe | Crystalline | Fe |
| 154 | Comparative Example | 90.0Fe—10.0Si | Crystalline | Fe |
| 155 | Example | 90.0Fe—10.0Si | Crystalline | Fe |
| 156 | Comparative Example | 81.6Fe—13.4B—3.4Si—1.6C | Amorphous | Fe |
| 157 | Example | 81.6Fe—13.4B—3.4Si—1.6C | Amorphous | Fe |
| 158 | Comparative Example | 73.5Fe—13.5Si—9.0B—3.0Nb—1.0Cu | Nanocrystalline | Fe |
| 159 | Example | 73.5Fe—13.5Si—9.0B—3.0Nb—1.0Cu | Nanocrystalline | Fe |
| 160 | Comparative Example | 80.5Fe—9.0Co—8.5Si—2.0Cr | Crystalline | Fe |
| 161 | Example | 80.5Fe—9.0Co—8.5Si—2.0Cr | Crystalline | Fe |
| 162 | Comparative Example | 57.4Fe—24.6Co—11.0B—3.0P—3.0Si—1.0Cr | Amorphous | Fe |
| 163 | Example | 57.4Fe—24.6Co—11.0B—3.0P—3.0Si—1.0Cr | Amorphous | Fe |
| 164 | Comparative Example | 55.3Fe—23.7Co—11.0B—2.0P—3.0Si—5.0Nb | Nanocrystalline | Fe |
| 165 | Example | 55.3Fe—23.7Co—11.0B—2.0P—3.0Si—5.0Nb | Nanocrystalline | Fe |
| 166 | Comparative Example | Fe | Crystalline | 90.0Fe—10.0Si |
| 167 | Example | Fe | Crystalline | 90.0Fe—10.0Si |
| 168 | Comparative Example | Fe | Crystalline | 81.6Fe—13.4B—3.4Si—1.6C |
| 169 | Example | Fe | Crystalline | 81.6Fe—13.4B—3.4Si—1.6C |
| 170 | Comparative Example | Fe | Crystalline | 73.5Fe—13.5Si—9.0B—3.0Nb—1.0Cu |
| 171 | Example | Fe | Crystalline | 73.5Fe—13.5Si—9.0B—3.0Nb—1.0Cu |
| 172 | Comparative Example | Fe | Crystalline | 80.5Fe—9.0Co—8.5Si—2.0Cr |
| 173 | Example | Fe | Crystalline | 80.5Fe—9.0Co—8.5Si—2.0Cr |
| 174 | Comparative Example | Fe | Crystalline | 57.4Fe—24.6Co—11.0B—3.0P—3.0Si—1.0Cr |
| 175 | Example | Fe | Crystalline | 57.4Fe—24.6Co—11.0B—3.0P—3.0Si—1.0Cr |
| 176 | Comparative Example | Fe | Crystalline | 55.3Fe—23.7Co—11.0B—2.0P—3.0Si—5.0Nb |
| 177 | Example | Fe | Crystalline | 55.3Fe—23.7Co—11.0B—2.0P—3.0Si—5.0Nb |
| 178 | Comparative Example | Fe | Crystalline | Fe |
| 179 | Example | Fe | Crystalline | Fe |
| 180 | Comparative Example | Fe | Crystalline | Fe |
| 181 | Example | Fe | Crystalline | Fe |
| 182 | Comparative Example | Fe | Crystalline | Fe |
| 183 | Example | Fe | Crystalline | Fe |
| 184 | Comparative Example | Fe | Crystalline | Fe |
| 185 | Example | Fe | Crystalline | Fe |
| 186 | Comparative Example | Fe | Crystalline | Fe |
| 187 | Example | Fe | Crystalline | Fe |
| 188 | Comparative Example | Fe | Crystalline | Fe |
| 189 | Example | Fe | Crystalline | Fe |
| 190 | Comparative Example | 57.4Fe—24.6Co—11.0B—3.0P—3.0Si—1.0Cr | Amorphous | 57.4Fe—24.6Co—11.0B—3.0P—3.0Si—1.0Cr |
| 191 | Example | 57.4Fe—24.6Co—11.0B—3.0P—3.0Si—1.0Cr | Amorphous | 57.4Fe—24.6Co—11.0B—3.0P—3.0Si—1.0Cr |
| 192 | Comparative Example | Fe | Crystalline | 57.4Fe—24.6Co—11.0B—3.0P—3.0Si—1.0Cr |
| 193 | Example | Fe | Crystalline | 57.4Fe—24.6Co—11.0B—3.0P—3.0Si—1.0Cr |
| 194 | Comparative Example | 57.4Fe—24.6Co—11.0B—3.0P—3.0Si—1.0Cr | Amorphous | 57.4Fe—24.6Co—11.0B—3.0P—3.0Si—1.0Cr |
| 195 | Example | 57.4Fe—24.6Co—11.0B—3.0P—3.0Si—1.0Cr | Amorphous | 57.4Fe—24.6Co—11.0B—3.0P—3.0Si—1.0Cr |

| Sam- | Powder | | |
|---|---|---|---|
| ple | Powder B | Powder C | |
| No. | Microstructure | Composition (atomic ratio) | Microstructure |
| 148 | Crystalline | Fe | Crystalline |
| 149 | Crystalline | Fe | Crystalline |
| 154 | Crystalline | Fe | Crystalline |
| 155 | Crystalline | Fe | Crystalline |
| 156 | Crystalline | Fe | Crystalline |
| 157 | Crystalline | Fe | Crystalline |
| 158 | Crystalline | Fe | Crystalline |
| 159 | Crystalline | Fe | Crystalline |
| 160 | Crystalline | Fe | Crystalline |
| 161 | Crystalline | Fe | Crystalline |
| 162 | Crystalline | Fe | Crystalline |
| 163 | Crystalline | Fe | Crystalline |
| 164 | Crystalline | Fe | Crystalline |
| 165 | Crystalline | Fe | Crystalline |
| 166 | Crystalline | Fe | Crystalline |
| 167 | Crystalline | Fe | Crystalline |
| 168 | Amorphous | Fe | Crystalline |
| 169 | Amorphous | Fe | Crystalline |
| 170 | Nanocrystalline | Fe | Crystalline |
| 171 | Nanocrystalline | Fe | Crystalline |
| 172 | Crystalline | Fe | Crystalline |
| 173 | Crystalline | Fe | Crystalline |
| 174 | Amorphous | Fe | Crystalline |
| 175 | Amorphous | Fe | Crystalline |
| 176 | Nanocrystalline | Fe | Crystalline |
| 177 | Nanocrystalline | Fe | Crystalline |
| 178 | Crystalline | 90.0Fe—10.0Si | Crystalline |
| 179 | Crystalline | 90.0Fe—10.0Si | Crystalline |
| 180 | Crystalline | 81.6Fe—13.4B—3.4Si—1.6C | Amorphous |
| 181 | Crystalline | 81.6Fe—13.4B—3.4Si—1.6C | Amorphous |
| 182 | Crystalline | 73.5Fe—13.5Si—9.0B—3.0Nb—1.0Cu | Nanocrystalline |
| 183 | Crystalline | 73.5Fe—13.5Si—9.0B—3.0Nb—1.0Cu | Nanocrystalline |
| 184 | Crystalline | 80.5Fe—9.0Co—8.5Si—2.0Cr | Crystalline |
| 185 | Crystalline | 80.5Fe—9.0Co—8.5Si—2.0Cr | Crystalline |
| 186 | Crystalline | 57.4Fe—24.6Co—11.0B—3.0P—3.0Si—1.0Cr | Amorphous |
| 187 | Crystalline | 57.4Fe—24.6Co—11.0B—3.0P—3.0Si—1.0Cr | Amorphous |
| 188 | Crystalline | 55.3Fe—23.7Co—11.0B—2.0P—3.0Si—5.0Nb | Nanocrystalline |
| 189 | Crystalline | 55.3Fe—23.7Co—11.0B—2.0P—3.0Si—5.0Nb | Nanocrystalline |
| 190 | Amorphous | Fe | Crystalline |
| 191 | Amorphous | Fe | Crystalline |
| 192 | Amorphous | 57.4Fe—24.6Co—11.0B—3.0P—3.0Si—1.0Cr | Amorphous |
| 193 | Amorphous | 57.4Fe—24.6Co—11.0B—3.0P—3.0Si—1.0Cr | Amorphous |
| 194 | Amorphous | 57.4Fe—24.6Co—11.0B—3.0P—3.0Si—1.0Cr | Amorphous |
| 195 | Amorphous | 57.4Fe—24.6Co—11.0B—3.0P—3.0Si—1.0Cr | Amorphous |

TABLE 6B

| | | | | | | Rate of | Rate of |
|---|---|---|---|---|---|---|---|
| | | Oxide phase | | | | decrease in | increase in |
| | | formation treatment | | Oxide phase | | relative | withstand |
| Sample | Example/ | Temperature | Pressure | T1 | T2 | permeability | voltage |
| No. | Comparative Example | (° C.) | (MPa) | (μm) | (μm) | (%) | (%) |
| 148 | Comparative Example | N/A | | 0.000 | 0.000 | — | — |
| 149 | Example | 150 | 0.20 | 1.986 | 0.085 | 4.5 | 79.9 |
| 154 | Comparative Example | N/A | | 0.000 | 0.000 | — | — |
| 155 | Example | 150 | 0.20 | 1.984 | 0.079 | 3.8 | 80.0 |
| 156 | Comparative Example | N/A | | 0.000 | 0.000 | — | — |
| 157 | Example | 150 | 0.20 | 1.869 | 0.073 | 3.4 | 79.6 |
| 158 | Comparative Example | N/A | | 0.000 | 0.000 | — | — |
| 159 | Example | 150 | 0.20 | 1.583 | 0.061 | 3.0 | 79.7 |
| 160 | Comparative Example | N/A | | 0.000 | 0.000 | — | — |
| 161 | Example | 150 | 0.20 | 1.213 | 0.047 | 2.4 | 84.5 |
| 162 | Comparative Example | N/A | | 0.000 | 0.000 | — | — |
| 163 | Example | 150 | 0.20 | 1.167 | 0.046 | 2.3 | 85.1 |
| 164 | Comparative Example | N/A | | 0.000 | 0.000 | — | — |
| 165 | Example | 150 | 0.20 | 1.150 | 0.045 | 2.3 | 84.8 |
| 166 | Comparative Example | N/A | | 0.000 | 0.000 | — | — |
| 167 | Example | 150 | 0.20 | 1.985 | 0.084 | 4.3 | 79.8 |
| 168 | Comparative Example | N/A | | 0.000 | 0.000 | — | — |
| 169 | Example | 150 | 0.20 | 1.985 | 0.085 | 4.3 | 80.1 |
| 170 | Comparative Example | N/A | | 0.000 | 0.000 | — | — |
| 171 | Example | 150 | 0.20 | 1.928 | 0.083 | 4.3 | 80.2 |
| 172 | Comparative Example | N/A | | 0.000 | 0.000 | — | — |
| 173 | Example | 150 | 0.20 | 1.872 | 0.086 | 4.2 | 81.3 |
| 174 | Comparative Example | N/A | | 0.000 | 0.000 | — | — |
| 175 | Example | 150 | 0.20 | 1.866 | 0.087 | 4.2 | 81.8 |
| 176 | Comparative Example | N/A | | 0.000 | 0.000 | — | — |
| 177 | Example | 150 | 0.20 | 1.864 | 0.085 | 4.2 | 81.5 |
| 178 | Comparative Example | N/A | | 0.000 | 0.000 | — | — |
| 179 | Example | 150 | 0.20 | 1.989 | 0.086 | 4.5 | 80.0 |
| 180 | Comparative Example | N/A | | 0.000 | 0.000 | — | — |
| 181 | Example | 150 | 0.20 | 1.987 | 0.085 | 4.5 | 80.0 |
| 182 | Comparative Example | N/A | | 0.000 | 0.000 | — | — |
| 183 | Example | 150 | 0.20 | 1.988 | 0.085 | 4.5 | 79.8 |
| 184 | Comparative Example | N/A | | 0.000 | 0.000 | — | — |
| 185 | Example | 150 | 0.20 | 1.988 | 0.084 | 4.4 | 80.3 |
| 186 | Comparative Example | N/A | | 0.000 | 0.000 | — | — |
| 187 | Example | 150 | 0.20 | 1.986 | 0.084 | 4.4 | 80.2 |
| 188 | Comparative Example | N/A | | 0.000 | 0.000 | — | — |
| 189 | Example | 150 | 0.20 | 1.985 | 0.084 | 4.4 | 80.5 |
| 190 | Comparative Example | N/A | | 0.000 | 0.000 | — | — |
| 191 | Example | 150 | 0.20 | 1.164 | 0.043 | 2.2 | 85.4 |
| 192 | Comparative Example | N/A | | 0.000 | 0.000 | — | — |
| 193 | Example | 150 | 0.20 | 1.863 | 0.085 | 2.3 | 85.3 |
| 194 | Comparative Example | N/A | | 0.000 | 0.000 | — | — |
| 195 | Example | 150 | 0.20 | 1.168 | 0.047 | 2.4 | 84.9 |

According to Tables 6A and 6B, there was a similar tendency as in Experiment 5 despite the composition and the microstructure of the powders being changed.

### (Experiment 7)

Sample Nos. 196 to 199 were carried out as in Sample Nos. 1 and 14 of Experiment 3 except that the powder was partly replaced with a powder that was prepared similarly to the original powder but had an average particle size of 1.0 μm. Sample Nos. 200 to 203 were carried out as in Sample Nos. 119 and 121 of Experiment 3 except that the powder was partly replaced with a powder that was prepared similarly to the original powder but had an average particle size of 1.0 μm. Sample Nos. 204 to 207 were carried out as in Sample Nos. 116 and 118 of Experiment 3 except that the powder was partly replaced with a powder that was prepared similarly to the original powder but had an average particle size of 1.0 μm. Table 7 shows the results.

TABLE 7

| | | | | | | | | | | Rate of | Rate of |
|---|---|---|---|---|---|---|---|---|---|---|---|
| | | Powder | | | | Oxide phase | | | | decrease in | increase in |
| | | Average particle size | | Mix ratio | | formation treatment | | Oxide phase | | relative | withstand |
| Sample | Example/ | (μm) | | (mass %) | | Temperature | Pressure | T1 | T2 | permeability | voltage |
| No. | Comparative Example | Powder A | Powder B | Powder A | Powder B | (° C.) | (MPa) | (μm) | (μm) | (%) | (%) |
| 1 | Comparative Example | 25 | 1.0 | 100 | 0 | N/A | | 0.000 | 0.000 | — | — |
| 14 | Example | 25 | 1.0 | 100 | 0 | 150 | 0.20 | 1.989 | 0.086 | 4.1 | 80.6 |
| 196 | Comparative Example | 25 | 1.0 | 80 | 20 | N/A | | 0.000 | 0.000 | — | — |
| 197 | Example | 25 | 1.0 | 80 | 20 | 150 | 0.20 | 1.987 | 0.086 | 4.5 | 80.5 |
| 198 | Comparative Example | 25 | 1.0 | 50 | 50 | N/A | | 0.000 | 0.000 | — | — |
| 199 | Example | 25 | 1.0 | 50 | 50 | 150 | 0.20 | 1.986 | 0.085 | 5.0 | 80.2 |
| 119 | Comparative Example | 10 | 1.0 | 100 | 0 | N/A | | 0.000 | 0.000 | — | — |
| 121 | Example | 10 | 1.0 | 100 | 0 | 150 | 0.20 | 2.010 | 0.086 | 8.1 | 81.0 |
| 200 | Comparative Example | 10 | 1.0 | 80 | 20 | N/A | | 0.000 | 0.000 | — | — |
| 201 | Example | 10 | 1.0 | 80 | 20 | 150 | 0.20 | 2.008 | 0.086 | 8.7 | 80.8 |
| 202 | Comparative Example | 10 | 1.0 | 50 | 50 | N/A | | 0.000 | 0.000 | — | — |
| 203 | Example | 10 | 1.0 | 50 | 50 | 150 | 0.20 | 2.007 | 0.085 | 9.2 | 80.4 |
| 116 | Comparative Example | 5.0 | 1.0 | 100 | 0 | N/A | | 0.000 | 0.000 | — | — |
| 118 | Example | 5.0 | 1.0 | 100 | 0 | 150 | 0.20 | 1.994 | 0.087 | 11.0 | 81.3 |
| 204 | Comparative Example | 5.0 | 1.0 | 80 | 20 | N/A | | 0.000 | 0.000 | — | — |
| 205 | Example | 5.0 | 1.0 | 80 | 20 | 150 | 0.20 | 1.994 | 0.085 | 11.5 | 80.9 |
| 206 | Comparative Example | 5.0 | 1.0 | 50 | 50 | N/A | | 0.000 | 0.000 | — | — |
| 207 | Example | 5.0 | 1.0 | 50 | 50 | 150 | 0.20 | 1.993 | 0.085 | 12.2 | 80.5 |

According to Table 7, there was a similar tendency as in Experiment 3 despite multiple types of powders with different average particle sizes being mixed.

### (Experiment 8)

With the treatment temperature and the treatment time of the oxide phase formation treatment being changed from those of Sample No. 14 of Experiment 1 so as not to substantially change T1 or T2 therefrom, Sample Nos. 301 and 302 were carried out. Further, Co/α and P/α of the oxide phases of each sample were measured using SEM-EDS. Table 8 shows the results.

With the treatment temperature and the treatment time of the oxide phase formation treatment being changed from those of Sample No. 78 of Experiment 2 so as not to substantially change T1 or T2 therefrom, Sample Nos. 303 and 304 were carried out. Further, Co/α and P/α of the oxide phases of each sample were measured using SEM-EDS. Table 8 shows the results.

With the treatment temperature and the treatment time of the oxide phase formation treatment being changed from those of Sample No. 96 of Experiment 2 so as not to substantially change T1 or T2 therefrom, Sample Nos. 305 to 312 were carried out. Further, Co/α and P/α of the oxide phases of each sample were measured using SEM-EDS. Table 8 shows the results.

With the treatment temperature and the treatment time of the oxide phase formation treatment being changed from those of Sample No. 105 of Experiment 2 so as not to substantially change T1 or T2 therefrom, Sample Nos. 313 to 320 were carried out. Further, Co/α and P/α of the oxide phases of each sample were measured using SEM-EDS. Table 8 shows the results.

With the treatment temperature and the treatment time of the oxide phase formation treatment being changed from those of Sample No. 108 of Experiment 2 so as not to substantially change T1 or T2 therefrom, Sample Nos. 321 to 328 were carried out. Further, Co/α and P/α of the oxide phases of each sample were measured using SEM-EDS. Table 8 shows the results.

TABLE 8

| | | | | | | | | | | Rate of | |
|---|---|---|---|---|---|---|---|---|---|---|---|
| | | | | | | | | | | decrease | Rate of |
| | | | Oxide phase | | | | | | | in | increase |
| | | | formation treatment | | | | | | | relative | in with- |
| Sam- | Example/ | Powder | Temper- | Pres- | | Oxide phase | | | | perme- | stand |
| ple | Comparative | Composition | ature | sure | Time | T1 | T2 | Co/ | P/ | ability | voltage |
| No. | Example | (atomic ratio) | (° C.) | (MPa) | (min) | (μm) | (μm) | α | α | (%) | (%) |
| 1 | Comparative | 100.0Fe | N/A | | | 0.000 | 0.000 | — | — | — | — |
| | Example | | | | | | | | | | |
| 301 | Example | 100.0Fe | 80 | 0.20 | 300.00 | 1.991 | 0.087 | 0.00 | 0.00 | 4.1 | 80.6 |
| 14 | Example | 100.0Fe | 150 | 0.20 | 60.00 | 1.989 | 0.086 | 0.00 | 0.00 | 4.1 | 80.6 |
| 302 | Example | 100.0Fe | 250 | 0.20 | 10.00 | 1.992 | 0.088 | 0.00 | 0.00 | 4.1 | 80.3 |
| 77 | Comparative | 50.0Fe—50.0Co | N/A | | | 0.000 | 0.000 | — | — | — | — |
| | Example | | | | | | | | | | |
| 303 | Comparative | 50.0Fe—50.0Co | 80 | 0.20 | 300.00 | 1.523 | 0.061 | 0.25 | 0.00 | 3.1 | 86.1 |
| | Example | | | | | | | | | | |
| 78 | Example | 50.0Fe—50.0Co | 150 | 0.20 | 60.00 | 1.521 | 0.061 | 0.48 | 0.00 | 3.1 | 86.0 |
| 304 | Example | 50.0Fe—50.0Co | 250 | 0.20 | 10.00 | 1.521 | 0.062 | 0.70 | 0.00 | 3.1 | 86.2 |
| 95 | Comparative | 57.4Fe—24.6Co—11.0B—3.0P—3.0Si—1.0Cr | N/A | | | 0.000 | 0.000 | — | — | — | — |
| | Example | | | | | | | | | | |
| 305 | Example | 57.4Fe—24.6Co—11.0B—3.0P—3.0Si—1.0Cr | 80 | 0.20 | 300.00 | 1.158 | 0.045 | 0.17 | 0.48 | 2.4 | 104.0 |
| 306 | Example | 57.4Fe—24.6Co—11.0B—3.0P—3.0Si—1.0Cr | 90 | 0.20 | 250.00 | 1.155 | 0.048 | 0.18 | 0.45 | 2.4 | 103.3 |
| 307 | Example | 57.4Fe—24.6Co—11.0B—3.0P—3.0Si—1.0Cr | 100 | 0.20 | 200.00 | 1.158 | 0.048 | 0.19 | 0.40 | 2.4 | 98.3 |
| 308 | Example | 57.4Fe—24.6Co—11.0B—3.0P—3.0Si—1.0Cr | 120 | 0.20 | 150.00 | 1.156 | 0.047 | 0.25 | 0.22 | 2.4 | 92.0 |
| 309 | Example | 57.4Fe—24.6Co—11.0B—3.0P—3.0Si—1.0Cr | 130 | 0.20 | 100.00 | 1.158 | 0.045 | 0.27 | 0.10 | 2.4 | 90.1 |
| 96 | Example | 57.4Fe—24.6Co—11.0B—3.0P—3.0Si—1.0Cr | 150 | 0.20 | 60.00 | 1.167 | 0.047 | 0.29 | 0.04 | 2.4 | 85.0 |
| 310 | Example | 57.4Fe—24.6Co—11.0B—3.0P—3.0Si—1.0Cr | 180 | 0.20 | 30.00 | 1.167 | 0.046 | 0.29 | 0.03 | 2.4 | 85.0 |
| 311 | Example | 57.4Fe—24.6Co—11.0B—3.0P—3.0Si—1.0Cr | 200 | 0.20 | 20.00 | 1.152 | 0.049 | 0.30 | 0.03 | 2.4 | 84.8 |
| 312 | Example | 57.4Fe—24.6Co—11.0B—3.0P—3.0Si—1.0Cr | 250 | 0.20 | 10.00 | 1.158 | 0.049 | 0.30 | 0.03 | 2.4 | 85.1 |
| 104 | Comparative | 41.0Fe—41.0Co—11.0B—3.0P—3.0Si—1.0Cr | N/A | | | 0.000 | 0.000 | — | — | — | — |
| | Example | | | | | | | | | | |
| 313 | Example | 41.0Fe—41.0Co—11.0B—3.0P—3.0Si—1.0Cr | 80 | 0.20 | 300.00 | 1.156 | 0.047 | 0.28 | 0.47 | 2.4 | 103.9 |
| 314 | Example | 41.0Fe—41.0Co—11.0B—3.0P—3.0Si—1.0Cr | 90 | 0.20 | 250.00 | 1.158 | 0.045 | 0.30 | 0.44 | 2.4 | 102.8 |
| 315 | Example | 41.0Fe—41.0Co—11.0B—3.0P—3.0Si—1.0Cr | 100 | 0.20 | 200.00 | 1.154 | 0.047 | 0.32 | 0.39 | 2.4 | 97.8 |
| 316 | Example | 41.0Fe—41.0Co—11.0B—3.0P—3.0Si—1.0Cr | 120 | 0.20 | 150.00 | 1.155 | 0.049 | 0.42 | 0.20 | 2.4 | 92.6 |
| 317 | Example | 41.0Fe—41.0Co—11.0B—3.0P—3.0Si—1.0Cr | 130 | 0.20 | 100.00 | 1.153 | 0.044 | 0.45 | 0.10 | 2.4 | 90.0 |
| 105 | Example | 41.0Fe—41.0Co—11.0B—3.0P—3.0Si—1.0Cr | 150 | 0.20 | 60.00 | 1.155 | 0.046 | 0.48 | 0.04 | 2.4 | 85.0 |
| 318 | Example | 32.8Fe—49.2Co—11.0B—3.0P—3.0Si—1.0Cr | 180 | 0.20 | 30.00 | 1.156 | 0.049 | 0.49 | 0.03 | 2.4 | 84.9 |
| 319 | Example | 32.8Fe—49.2Co—11.0B—3.0P—3.0Si—1.0Cr | 200 | 0.20 | 20.00 | 1.160 | 0.048 | 0.50 | 0.03 | 2.4 | 85.0 |
| 320 | Example | 32.8Fe—49.2Co—11.0B—3.0P—3.0Si—1.0Cr | 250 | 0.20 | 10.00 | 1.158 | 0.044 | 0.50 | 0.03 | 2.4 | 84.8 |
| 107 | Comparative | 32.8Fe—49.2Co—11.0B—3.0P—3.0Si—1.0Cr | N/A | | | 0.000 | 0.000 | — | — | — | — |
| | Example | | | | | | | | | | |
| 321 | Example | 32.8Fe—49.2Co—11.0B—3.0P—3.0Si—1.0Cr | 80 | 0.20 | 300.00 | 1.154 | 0.044 | 0.34 | 0.46 | 2.4 | 104.2 |
| 322 | Example | 32.8Fe—49.2Co—11.0B—3.0P—3.0Si—1.0Cr | 90 | 0.20 | 250.00 | 1.155 | 0.046 | 0.36 | 0.43 | 2.4 | 103.0 |
| 323 | Example | 32.8Fe—49.2Co—11.0B—3.0P—3.0Si—1.0Cr | 100 | 0.20 | 200.00 | 1.156 | 0.047 | 0.38 | 0.38 | 2.4 | 98.0 |
| 324 | Example | 32.8Fe—49.2Co—11.0B—3.0P—3.0Si—1.0Cr | 120 | 0.20 | 150.00 | 1.157 | 0.045 | 0.51 | 0.19 | 2.4 | 92.3 |
| 325 | Example | 32.8Fe—49.2Co—11.0B—3.0P—3.0Si—1.0Cr | 130 | 0.20 | 100.00 | 1.150 | 0.047 | 0.54 | 0.10 | 2.4 | 90.2 |
| 108 | Example | 32.8Fe—49.2Co—11.0B—3.0P—3.0Si—1.0Cr | 150 | 0.20 | 60.00 | 1.155 | 0.046 | 0.56 | 0.08 | 2.4 | 85.0 |
| 326 | Example | 32.8Fe—49.2Co—11.0B—3.0P—3.0Si—1.0Cr | 180 | 0.20 | 30.00 | 1.157 | 0.050 | 0.58 | 0.03 | 2.4 | 85.1 |
| 327 | Example | 32.8Fe—49.2Co—11.0B—3.0P—3.0Si—1.0Cr | 200 | 0.20 | 20.00 | 1.154 | 0.043 | 0.59 | 0.03 | 2.4 | 84.8 |
| 328 | Example | 32.8Fe—49.2Co—11.0B—3.0P—3.0Si—1.0Cr | 250 | 0.20 | 10.00 | 1.154 | 0.045 | 0.60 | 0.03 | 2.4 | 85.0 |

According to Table 8, there was a similar tendency as in Experiments 1 and 2 despite Co/α and P/α of the oxide phases being changed without T1 and T2 substantially being changed.

### (Experiment 9)

As a master alloy, pure metal Fe was prepared. Pure metal Fe was heated and melted to provide a metal in a molten state (molten metal) having a temperature of 1600° C. Then, using the gas atomization method, a soft magnetic metal powder composed of pure metal Fe was manufactured. Specifically, at the time when the molten master alloy was discharged from a dripping molten metal discharge port to a cooling portion (cooling water) of a chamber, a high-pressure gas was sprayed to the discharged dripping molten metal. The pressure of the high-pressure gas was 5 MPa. The spray amount of the molten metal was 6 kg/min. Sieve classification was carried out so that the soft magnetic metal powder eventually obtained (pure iron powder in Experiment 9) had an average particle size of 25 μm.

It was confirmed, using an ICP analysis, that the composition of the master alloy and the composition of the soft magnetic metal powder approximately matched. The soft magnetic metal powder underwent an X-ray diffraction measurement to calculate the amorphous ratio X using the method described earlier. When the amorphous ratio X was 85% or more, the powder was deemed to have an amorphous structure. When the amorphous ratio X was less than 85% and the average crystallite size was 100 nm or less, the powder was deemed to have a nanocrystalline structure. When the amorphous ratio X was less than 85% and the average crystallite size exceeded 100 nm, the powder was deemed to have a crystalline structure. In Experiment 9, it was confirmed that the soft magnetic metal powder had a crystalline structure in all samples. The average particle size of the soft magnetic metal powder was checked using a SEM and was calculated.

Then, the soft magnetic metal powder (pure iron powder) and an epoxy resin were kneaded to provide a resin compound. The amount of the epoxy resin in the resin compound (resin amount) was 3 parts by mass with respect to 100 parts by mass soft magnetic metal powder.

Then, a mold was filled with the resin compound, and pressure was applied thereto, to provide a pressed body having a toroidal shape. The pressure applied at this time was controlled so that a magnetic core had a relative permeability (μ) of 30. The resultant pressed body was heat treated at 180° C. for 60 minutes to harden the epoxy resin, providing the magnetic core having a toroidal shape. The magnetic core had an outside diameter of 11 mm, an inside diameter of 6.5 mm, and a thickness of 2.5 mm.

Then, the oxide phase formation treatment was performed to the magnetic core having the toroidal shape except for Sample No. 401. First, the magnetic core and water were sealed in a metal sealed container. Then, the sealed container was once decompressed and had pressure applied thereto using a nitrogen gas. The sealed container was then heated. Table 9 shows the amount of water (sealed amount) with respect to 100 parts by mass magnetic core and the temperature of the inside of the sealed container. In Sample No. 402, the amount of water was 0, i.e., water was not sealed in the sealed container. In Sample Nos. 402 to 444, the pressure of the atmosphere inside the sealed container was 0.20 MPa. The sealed container was held at a temperature shown in Table 9 for 60 minutes.

Another mold was filled with the resin compound, and pressure was applied thereto, to provide a pressed body having a rectangular parallelepiped shape. The pressure and heat treatment conditions were the same as those of the above magnetic core having the toroidal shape. The magnetic core had a square bottom surface measuring 4.0 mm×4.0 mm and had a height of 1.0 mm.

Then, the oxide phase formation treatment was performed to the magnetic core having the rectangular parallelepiped shape except for Sample No. 401. Conditions of the oxide phase formation treatment were the same as those of the above magnetic core having the toroidal shape.

### (Average Thicknesses of Oxide Phases)

A cross-section of the resultant magnetic core having the toroidal shape was observed. T3 and T4 were measured. T4/T3 was calculated. First, the cross-section of the magnetic core was observed with a SEM. At this time, the magnification was set low. Specifically, the magnification was set lower than that for measuring the thicknesses of oxide phases (described later). Through observation, a specific particle including an oxide phase having a maximum thickness of 0.005 μm or more was identified in a surface portion of the magnetic core. Hereinafter, a specific particle is deemed to include an oxide phase having a maximum thickness of 0.005 μm or more at a surface of the particle unless otherwise specified. In Experiments 9 to 16, the surface portion meant that of the second embodiment; a central portion meant that of the second embodiment; and the specific particle meant that of the second embodiment.

Then, to measure T3 and T4 of the identified specific particle, the magnification and the location of the field of view were appropriately controlled so that the specific particle in its entirety was observable. The magnification was appropriately controlled within a range of ×1000 to ×50000.

Then, T3 and T4 of at least fifty specific particles were measured, and T4/T3 was calculated. From the above measurement results and calculation results, average T3, average T4, and average T4/T3 were calculated. These values were deemed to be average T3, average T4, and average T4/T3 of the entire surface portion of the magnetic core. Table 9 shows average T3, average T4, and average T4/T3.

In a situation where at least fifty specific particles were not identified in the surface portion, average T3, average T4, and average T4/T3 were calculated from the thicknesses of the oxide phases of all specific particles identified in the surface portion.

In Sample Nos. 401, in which the oxide phase formation treatment was not performed, and Sample No. 402, in which water was not added during the oxide phase formation treatment, no specific particles were included in the magnetic core.

In Sample Nos. 401 and 402, all soft magnetic metal particles were deemed to have T3=T4=0.000.

### (Relative Permeability)

Relative permeability of the resultant magnetic core having the toroidal shape was measured. First, around the magnetic core having the toroidal shape, a polyurethane wire (UEW wire) was wound. Using an LCR meter (4284A manufactured by Agilent Technologies), relative permeability of the magnetic core was measured at a measurement frequency of 1 MHz. In Table 9, relative permeability is rounded off to one decimal place. Thus, despite relative permeability values shown in Table 9 being the same, rates of decrease in relative permeability may differ.

For each sample, the rate of decrease in relative permeability relative to that of a Comparative Example carried out under the same conditions except that the oxide phase formation treatment was not performed (Sample No. 401 in Experiment 9) was calculated. Each table shows the results. Relative permeability was deemed good when the rate of decrease in relative permeability was 15.0% or less or was deemed better when the rate of decrease was 10.0% or less.

### (Withstand Voltage)

Withstand voltage of the resultant magnetic core having the rectangular parallelepiped shape was measured. First, one of two square surfaces, measuring 4.0 mm×4.0 mm, of the magnetic core having the rectangular parallelepiped shape was selected. Then, the selected surface was provided with terminal electrodes having a width of 1.3 mm at both ends. The distance between the terminal electrodes was 1.4 mm.

Then, a voltage was applied between the terminal electrodes. The voltage at which a current of 2 mA flowed was measured as withstand voltage. In Table 9, withstand voltage is rounded off to the nearest whole number. Thus, despite withstand voltages shown in Table 9 being the same, rates of increase in withstand voltage may differ.

For each sample, the rate of increase in withstand voltage relative to that of a Comparative Example carried out under the same conditions except that the oxide phase formation treatment was not performed (Sample No. 401 in Experiment 9) was calculated. Each table shows the results. Withstand voltage was deemed good when the rate of increase in withstand voltage was 10.0% or more or was deemed better when the rate of increase was 20.0% or more.

TABLE 9

| | | Oxide phase | | | | | | | | |
|---|---|---|---|---|---|---|---|---|---|---|
| | | formation treatment | | | | | | Rate of | | Rate of |
| | | | Water | | | | | decrease in | | increase in |
| | | | amount | Oxide phase | | | | relative | Withstand | withstand |
| Sample | Example/ | Temperature | (parts by | T3 | T4 | | Relative | permeability | voltage | voltage |
| No. | Comparative Example | (° C.) | mass) | (μm) | (μm) | T4/T3 | permeability | (%) | (V) | (%) |
| 401 | Comparative Example | N/A | | 0.000 | 0.000 | — | 30.0 | — | 200 | — |
| 402 | Comparative Example | 200 | 0 | 0.000 | 0.000 | — | 30.0 | 0.0 | 200 | 0.0 |
| 403 | Example | 90 | 0.5 | 0.005 | 0.002 | 0.40 | 30.0 | 0.1 | 220 | 10.0 |
| 404 | Example | 90 | 1 | 0.025 | 0.004 | 0.08 | 30.0 | 0.1 | 220 | 10.1 |
| 405 | Example | 90 | 5 | 0.051 | 0.016 | 0.21 | 30.0 | 0.1 | 220 | 10.2 |
| 406 | Example | 90 | 15 | 0.084 | 0.024 | 0.29 | 29.9 | 0.2 | 220 | 10.2 |
| 407 | Example | 90 | 25 | 0.089 | 0.037 | 0.42 | 29.9 | 0.2 | 230 | 14.9 |
| 408 | Example | 90 | 30 | 0.098 | 0.050 | 0.51 | 29.9 | 0.2 | 230 | 15.0 |
| 409 | Example | 100 | 0.5 | 0.080 | 0.008 | 0.10 | 30.0 | 0.1 | 220 | 10.2 |
| 410 | Example | 100 | 1 | 0.150 | 0.027 | 0.18 | 29.9 | 0.3 | 254 | 27.2 |
| 411 | Example | 100 | 5 | 0.200 | 0.064 | 0.32 | 29.9 | 0.4 | 271 | 35.3 |
| 412 | Example | 100 | 15 | 0.279 | 0.112 | 0.40 | 29.8 | 0.6 | 280 | 40.1 |
| 413 | Example | 100 | 25 | 0.287 | 0.149 | 0.52 | 29.8 | 0.7 | 289 | 44.6 |
| 414 | Example | 100 | 30 | 0.297 | 0.181 | 0.61 | 29.8 | 0.8 | 296 | 48.0 |
| 415 | Example | 120 | 0.5 | 0.100 | 0.020 | 0.20 | 29.9 | 0.2 | 229 | 20.0 |
| 416 | Example | 120 | 1 | 0.200 | 0.056 | 0.28 | 29.9 | 0.5 | 265 | 32.5 |
| 417 | Example | 120 | 5 | 0.400 | 0.164 | 0.41 | 29.7 | 0.9 | 300 | 50.2 |
| 418 | Example | 120 | 15 | 0.672 | 0.336 | 0.50 | 29.6 | 1.3 | 321 | 60.3 |
| 419 | Example | 120 | 25 | 0.680 | 0.422 | 0.62 | 29.6 | 1.5 | 325 | 62.4 |
| 420 | Example | 120 | 30 | 0.686 | 0.473 | 0.69 | 29.5 | 1.7 | 326 | 63.6 |
| 421 | Example | 130 | 0.5 | 0.500 | 0.145 | 0.29 | 29.7 | 1.0 | 304 | 52.0 |
| 422 | Example | 130 | 1 | 0.800 | 0.328 | 0.41 | 29.5 | 1.6 | 326 | 63.0 |
| 423 | Example | 130 | 5 | 1.000 | 0.470 | 0.47 | 29.4 | 2.1 | 334 | 67.0 |
| 424 | Example | 130 | 15 | 1.250 | 0.763 | 0.61 | 29.3 | 2.4 | 341 | 70.5 |
| 425 | Example | 130 | 25 | 1.267 | 0.862 | 0.68 | 29.2 | 2.7 | 349 | 74.4 |
| 426 | Example | 130 | 30 | 1.282 | 0.962 | 0.75 | 29.2 | 2.8 | 351 | 75.4 |
| 427 | Example | 150 | 0.5 | 0.500 | 0.210 | 0.42 | 29.9 | 1.1 | 310 | 55.0 |
| 428 | Example | 150 | 1 | 0.800 | 0.416 | 0.52 | 29.9 | 1.8 | 327 | 63.3 |
| 429 | Example | 150 | 5 | 1.000 | 0.600 | 0.60 | 29.7 | 2.2 | 340 | 70.0 |
| 430 | Example | 150 | 15 | 2.332 | 1.632 | 0.70 | 28.8 | 4.1 | 361 | 80.6 |
| 431 | Example | 150 | 25 | 2.326 | 1.745 | 0.75 | 27.1 | 4.2 | 364 | 82.0 |
| 432 | Example | 150 | 30 | 2.340 | 1.895 | 0.81 | 25.5 | 4.4 | 366 | 82.8 |
| 433 | Example | 180 | 0.5 | 2.000 | 0.900 | 0.45 | 29.0 | 3.2 | 357 | 78.5 |
| 434 | Example | 180 | 1 | 3.000 | 2.010 | 0.67 | 28.6 | 4.8 | 371 | 85.5 |
| 435 | Example | 180 | 5 | 4.000 | 2.880 | 0.72 | 28.1 | 6.2 | 380 | 89.8 |
| 436 | Example | 180 | 15 | 5.578 | 4.462 | 0.80 | 27.6 | 8.1 | 392 | 96.0 |
| 437 | Example | 180 | 25 | 5.585 | 4.747 | 0.85 | 27.5 | 8.5 | 396 | 97.8 |
| 438 | Example | 180 | 30 | 5.598 | 5.038 | 0.90 | 27.4 | 8.7 | 397 | 98.3 |
| 439 | Example | 200 | 0.5 | 5.000 | 2.350 | 0.47 | 28.1 | 6.3 | 381 | 90.5 |
| 440 | Example | 200 | 1 | 6.000 | 4.080 | 0.68 | 27.5 | 8.2 | 392 | 96.0 |
| 441 | Example | 200 | 5 | 7.700 | 6.391 | 0.83 | 27.0 | 9.5 | 419 | 109.4 |
| 442 | Example | 200 | 15 | 10.400 | 9.464 | 0.91 | 26.2 | 12.7 | 444 | 122.0 |
| 443 | Example | 200 | 25 | 10.550 | 10.339 | 0.98 | 25.5 | 14.9 | 455 | 127.3 |
| 444 | Comparative Example | 200 | 30 | 10.572 | 10.572 | 1.00 | 23.4 | 22.0 | 458 | 129.2 |

According to Table 9, in Sample Nos. 403 to 443, in which the oxide phase formation treatment was performed under suitable conditions, T4/T3 was within a predetermined range. Consequently, it was possible to improve withstand voltage while a decrease in relative permeability was mitigated compared to Sample No. 401, which was carried out under the same conditions except that the oxide phase formation treatment was not performed.

In Sample No. 402, in which water was not added during the oxide phase formation treatment, no oxide phase was formed similarly to Sample No. 401. Consequently, neither relative permeability nor withstand voltage changed from those of Sample No. 401.

In Sample No. 444, in which the treatment temperature of the oxide phase formation treatment was high and the amount of water was large, T4/T3 was too large. Consequently, relative permeability was significantly lower than that of Sample No. 401, which was carried out under the same conditions except that the oxide phase formation treatment was not performed.

### (Experiment 10)

With the composition and the microstructure of the soft magnetic metal powder being changed from those of Sample Nos. 401, 433, and 437 of Experiment 9, Experiment 10 was conducted.

The composition of the soft magnetic metal powder was changed by changing the composition of the master alloy. The temperature of the molten metal was appropriately controlled within a range of 1200° C. to 1600° C. according to the composition of the molten metal.

Tables 10A to 10C show the composition of the soft magnetic metal powder and the results. The composition is shown in terms of atomicity. Note that, in Experiment 10 and subsequent Experiments, descriptions of relative permeability and withstand voltage are omitted. Only the rate of decrease in relative permeability and the rate of increase in withstand voltage relative to a sample that had the same composition but did not undergo the oxide phase formation treatment are shown.

Using XRD, it was confirmed that the powder had a crystalline structure in all of Sample Nos. 445 to 462, 469 to 474, and 487 to 501.

Using XRD, it was confirmed that the powder had an amorphous structure in all of Sample Nos. 463 to 465, 475 to 480, 502 to 507, and 514 to 519.

In Sample Nos. 466 to 468, 481 to 486, and 508 to 513, the powder was heat treated after being prepared using the gas atomization method to deposit nanocrystals with a crystallite size of 30 nm or less. The heat treatment was performed specifically at 400° C. to 650° C. for 10 to 60 minutes. Using XRD, it was confirmed that the powder had a nanocrystalline structure in all of Sample Nos. 466 to 468, 481 to 486, and 508 to 513.

TABLE 10A

| | | | | Oxide phase | | | | | Rate of | |
|---|---|---|---|---|---|---|---|---|---|---|
| | | | | formation treatment | | | | | decrease | Rate of |
| | | | | | Water | | | | in | increase |
| | | | | | amount | | | | relative | in with- |
| Sam- | | Powder | | Temper- | (parts | Oxide phase | | | perme- | stand |
| ple | Example/ | | Micro- | ature | by | T3 | T4 | T4/ | ability | voltage |
| No. | Comparative Example | Composition | structure | (° C.) | mass) | (μm) | (μm) | T3 | (%) | (%) |
| 401 | Comparative Example | 100.0Fe | Crystalline | N/A | | 0.000 | 0.000 | — | — | — |
| 433 | Example | 100.0Fe | Crystalline | 180 | 0.5 | 2.000 | 0.900 | 0.45 | 3.2 | 78.5 |
| 437 | Example | 100.0Fe | Crystalline | 180 | 25 | 5.585 | 4.747 | 0.85 | 8.5 | 97.8 |
| 445 | Comparative Example | 80.0Fe—20.0Ni | Crystalline | N/A | | 0.000 | 0.000 | — | — | — |
| 446 | Example | 80.0Fe—20.0Ni | Crystalline | 180 | 0.5 | 1.680 | 0.739 | 0.44 | 2.9 | 75.0 |
| 447 | Example | 80.0Fe—20.0Ni | Crystalline | 180 | 25 | 4.482 | 3.810 | 0.85 | 6.9 | 93.5 |
| 448 | Comparative Example | 50.0Fe—50.0Ni | Crystalline | N/A | | 0.000 | 0.000 | — | — | — |
| 449 | Example | 50.0Fe—50.0Ni | Crystalline | 180 | 0.5 | 1.212 | 0.533 | 0.44 | 2.1 | 70.5 |
| 450 | Example | 50.0Fe—50.0Ni | Crystalline | 180 | 25 | 2.982 | 2.505 | 0.84 | 5.0 | 87.6 |
| 451 | Comparative Example | 20.0Fe—80.0Ni | Crystalline | N/A | | 0.000 | 0.000 | — | — | — |
| 452 | Example | 20.0Fe—80.0Ni | Crystalline | 180 | 0.5 | 0.512 | 0.225 | 0.44 | 1.2 | 56.1 |
| 453 | Example | 20.0Fe—80.0Ni | Crystalline | 180 | 25 | 1.312 | 1.102 | 0.84 | 2.9 | 75.8 |
| 454 | Comparative Example | 100.0Ni | Crystalline | N/A | | 0.000 | 0.000 | — | — | — |
| 455 | Example | 100.0Ni | Crystalline | 180 | 0.5 | 0.062 | 0.027 | 0.43 | 0.1 | 10.5 |
| 456 | Example | 100.0Ni | Crystalline | 180 | 25 | 0.163 | 0.137 | 0.84 | 0.5 | 37.6 |
| 457 | Comparative Example | 90.0Fe—10.0Si | Crystalline | N/A | | 0.000 | 0.000 | — | — | — |
| 458 | Example | 90.0Fe—10.0Si | Crystalline | 180 | 0.5 | 1.875 | 0.844 | 0.45 | 3.1 | 77.4 |
| 459 | Example | 90.0Fe—10.0Si | Crystalline | 180 | 25 | 5.120 | 4.352 | 0.85 | 7.9 | 94.7 |
| 460 | Comparative Example | 89.4Fe—8.6Si—2.0Cr | Crystalline | N/A | | 0.000 | 0.000 | — | — | — |
| 461 | Example | 89.4Fe—8.6Si—2.0Cr | Crystalline | 180 | 0.5 | 1.821 | 0.819 | 0.45 | 3.0 | 76.8 |
| 462 | Example | 89.4Fe—8.6Si—2.0Cr | Crystalline | 180 | 25 | 4.924 | 4.235 | 0.86 | 7.8 | 94.3 |
| 463 | Comparative Example | 75.0Fe—10.0Si—15.0B | Amorphous | N/A | | 0.000 | 0.000 | — | — | — |
| 464 | Example | 75.0Fe—10.0Si—15.0B | Amorphous | 180 | 0.5 | 1.588 | 0.699 | 0.44 | 2.8 | 74.2 |
| 465 | Example | 75.0Fe—10.0Si—15.0B | Amorphous | 180 | 25 | 4.278 | 3.636 | 0.85 | 6.8 | 92.3 |
| 466 | Comparative Example | 73.5Fe—13.5Si—9.0B—3.0Nb—1.0Cu | Nano- | N/A | | 0.000 | 0.000 | — | — | — |
| | | | crystalline | | | | | | | |
| 467 | Example | 73.5Fe—13.5Si—9.0B—3.0Nb—1.0Cu | Nano- | 180 | 0.5 | 1.499 | 0.675 | 0.45 | 2.7 | 73.8 |
| | | | crystalline | | | | | | | |
| 468 | Example | 73.5Fe—13.5Si—9.0B—3.0Nb—1.0Cu | Nano- | 180 | 25 | 4.210 | 3.536 | 0.84 | 6.6 | 91.1 |
| | | | crystalline | | | | | | | |

TABLE 10B

| | | | | | | | | | Rate of | |
|---|---|---|---|---|---|---|---|---|---|---|
| | | | | Oxide phase | | | | | decrease | Rate of |
| | | | | formation treatment | | | | | in | increase |
| | | | | | Water | | | | relative | in with- |
| Sam- | Example/ | Powder | | Temper- | amount | Oxide phase | | | perme- | stand |
| ple | Comparative | | Micro- | ature | (parts | T3 | T4 | T4/ | ability | voltage |
| No. | Example | Composition | structure | (° C.) | by mass) | (μm) | (μm) | T3 | (%) | (%) |
| 469 | Comparative | 73.7Fe—16.4Si—9.9Al | Crystalline | N/A | | 0.000 | 0.000 | — | — | — |
| | Example | | | | | | | | | |
| 470 | Example | 73.7Fe—16.4Si—9.9Al | Crystalline | 180 | 0.5 | 1.501 | 0.751 | 0.50 | 2.9 | 74.3 |
| 471 | Example | 73.7Fe—16.4Si—9.9Al | Crystalline | 180 | 25 | 4.142 | 3.521 | 0.85 | 6.4 | 91.5 |
| 472 | Comparative | 59.0Fe—16.4Si—9.9Al—14.7Ni | Crystalline | N/A | | 0.000 | 0.000 | — | — | — |
| | Example | | | | | | | | | |
| 473 | Example | 59.0Fe—16.4Si—9.9Al—14.7Ni | Crystalline | 180 | 0.5 | 1.213 | 0.594 | 0.49 | 2.1 | 71.8 |
| 474 | Example | 59.0Fe—16.4Si—9.9Al—14.7Ni | Crystalline | 180 | 25 | 3.472 | 2.916 | 0.84 | 6.2 | 88.9 |
| 475 | Comparative | 81.6Fe—13.4B—3.4Si—1.6C | Amorphous | N/A | | 0.000 | 0.000 | — | — | — |
| | Example | | | | | | | | | |
| 476 | Example | 81.6Fe—13.4B—3.4Si—1.6C | Amorphous | 180 | 0.5 | 1.602 | 0.817 | 0.51 | 3.0 | 75.9 |
| 477 | Example | 81.6Fe—13.4B—3.4Si—1.6C | Amorphous | 180 | 25 | 4.692 | 3.988 | 0.85 | 7.6 | 94.1 |
| 478 | Comparative | 72.7Fe—10.8B—11.6Si—2.7C—2.2Cr | Amorphous | N/A | | 0.000 | 0.000 | — | — | — |
| | Example | | | | | | | | | |
| 479 | Example | 72.7Fe—10.8B—11.6Si—2.7C—2.2Cr | Amorphous | 180 | 0.5 | 1.487 | 0.744 | 0.50 | 2.8 | 74.3 |
| 480 | Example | 72.7Fe—10.8B—11.6Si—2.7C—2.2Cr | Amorphous | 180 | 25 | 4.191 | 3.520 | 0.84 | 6.7 | 91.5 |
| 481 | Comparative | 82.0Fe—11.0B—5.0P—1.0Si—1.0Cu | Nano- | N/A | | 0.000 | 0.000 | — | — | — |
| | Example | | crystalline | | | | | | | |
| 482 | Example | 82.0Fe—11.0B—5.0P—1.0Si—1.0Cu | Nano- | 180 | 0.5 | 1.632 | 0.783 | 0.48 | 3.1 | 76.1 |
| | | | crystalline | | | | | | | |
| 483 | Example | 82.0Fe—11.0B—5.0P—1.0Si—1.0Cu | Nano- | 180 | 25 | 4.603 | 3.959 | 0.86 | 7.5 | 93.8 |
| | | | crystalline | | | | | | | |
| 484 | Comparative | 78.0Fe—9.0B—3.0P—3.0Si—6.0Nb—1.0Cr | Nano- | N/A | | 0.000 | 0.000 | — | — | — |
| | Example | | crystalline | | | | | | | |
| 485 | Example | 78.0Fe—9.0B—3.0P—3.0Si—6.0Nb—1.0Cr | Nano- | 180 | 0.5 | 1.576 | 0.772 | 0.49 | 2.9 | 74.8 |
| | | | crystalline | | | | | | | |
| 486 | Example | 78.0Fe—9.0B—3.0P—3.0Si—6.0Nb—1.0Cr | Nano- | 180 | 25 | 4.478 | 3.806 | 0.85 | 7.3 | 92.9 |
| | | | crystalline | | | | | | | |

TABLE 10C

| | | | | Oxide phase | | | | | Rate of | |
|---|---|---|---|---|---|---|---|---|---|---|
| | | | | formation treatment | | | | | decrease | Rate of |
| | | | | | Water | | | | in | increase |
| | | | | | amount | | | | relative | in with- |
| Sam- | Example/ | Powder | | Temper- | (parts | Oxide phase | | | perme- | stand |
| ple | Comparative | | Micro- | ature | by | T3 | T4 | T4/ | ability | voltage |
| No. | Example | Composition | structure | (° C.) | mass) | (μm) | (μm) | T3 | (%) | (%) |
| 487 | Comparative | 50.0Fe—50.0Co | Crystalline | N/A | | 0.000 | 0.000 | — | — | — |
| | Example | | | | | | | | | |
| 488 | Example | 50.0Fe—50.0Co | Crystalline | 180 | 0.5 | 2.091 | 1.025 | 0.49 | 3.6 | 88.8 |
| 489 | Example | 50.0Fe—50.0Co | Crystalline | 180 | 25 | 5.609 | 4.768 | 0.85 | 8.4 | 107.3 |
| 490 | Comparative | 49.0Fe—49.0Co—2.0V | Crystalline | N/A | | 0.000 | 0.000 | — | — | — |
| | Example | | | | | | | | | |
| 491 | Example | 49.0Fe—49.0Co—2.0V | Crystalline | 180 | 0.5 | 1.998 | 0.999 | 0.50 | 3.5 | 88.2 |
| 492 | Example | 49.0Fe—49.0Co—2.0V | Crystalline | 180 | 25 | 5.530 | 4.701 | 0.85 | 8.3 | 106.9 |
| 493 | Comparative | 83.6Fe—4.4Co—12.0Si | Crystalline | N/A | | 0.000 | 0.000 | — | — | — |
| | Example | | | | | | | | | |
| 494 | Example | 83.6Fe—4.4Co—12.0Si | Crystalline | 180 | 0.5 | 1.860 | 0.949 | 0.51 | 3.2 | 87.5 |
| 495 | Example | 83.6Fe—4.4Co—12.0Si | Crystalline | 180 | 25 | 5.000 | 4.200 | 0.84 | 7.7 | 105.3 |
| 496 | Comparative | 36.9Fe—36.8Co—16.4Si—9.9Al | Crystalline | N/A | | 0.000 | 0.000 | — | — | — |
| | Example | | | | | | | | | |
| 497 | Example | 36.9Fe—36.8Co—16.4Si—9.9Al | Crystalline | 180 | 0.5 | 1.567 | 0.784 | 0.50 | 2.8 | 85.1 |
| 498 | Example | 36.9Fe—36.8Co—16.4Si—9.9Al | Crystalline | 180 | 25 | 4.276 | 3.677 | 0.86 | 6.8 | 103.2 |
| 499 | Comparative | 80.5Fe—9.0Co—8.5Si—2.0Cr | Crystalline | N/A | | 0.000 | 0.000 | — | — | — |
| | Example | | | | | | | | | |
| 500 | Example | 80.5Fe—9.0Co—8.5Si—2.0Cr | Crystalline | 180 | 0.5 | 1.912 | 0.937 | 0.49 | 3.3 | 87.6 |
| 501 | Example | 80.5Fe—9.0Co—8.5Si—2.0Cr | Crystalline | 180 | 25 | 5.165 | 4.494 | 0.87 | 8.0 | 106.3 |
| 502 | Comparative | 66.8Fe—16.7Co—11.0B—4.5P—1.0Si | Amorphous | N/A | | 0.000 | 0.000 | — | — | — |
| | Example | | | | | | | | | |
| 503 | Example | 66.8Fe—16.7Co—11.0B—4.5P—1.0Si | Amorphous | 180 | 0.5 | 1.724 | 0.828 | 0.48 | 3.0 | 86.6 |
| 504 | Example | 66.8Fe—16.7Co—11.0B—4.5P—1.0Si | Amorphous | 180 | 25 | 4.729 | 4.020 | 0.85 | 7.4 | 104.7 |
| 505 | Comparative | 57.4Fe—24.6Co—11.0B—3.0P—3.0Si—1.0Cr | Amorphous | N/A | | 0.000 | 0.000 | — | — | — |
| | Example | | | | | | | | | |
| 506 | Example | 57.4Fe—24.6Co—11.0B—3.0P—3.0Si—1.0Cr | Amorphous | 180 | 0.5 | 1.725 | 0.897 | 0.52 | 3.0 | 86.9 |
| 507 | Example | 57.4Fe—24.6Co—11.0B—3.0P—3.0Si—1.0Cr | Amorphous | 180 | 25 | 4.672 | 3.878 | 0.83 | 7.3 | 104.2 |
| 508 | Comparative | 62.4Fe—15.6Co—11.3B—5.0P—5.0Si—0.7Cu | Nano- | N/A | | 0.000 | 0.000 | — | — | — |
| | Example | | crystalline | | | | | | | |
| 509 | Example | 62.4Fe—15.6Co—11.3B—5.0P—5.0Si—0.7Cu | Nano- | 180 | 0.5 | 1.625 | 0.813 | 0.50 | 2.9 | 85.6 |
| | | | crystalline | | | | | | | |
| 510 | Example | 62.4Fe—15.6Co—11.3B—5.0P—5.0Si—0.7Cu | Nano- | 180 | 25 | 4.485 | 3.812 | 0.85 | 7.1 | 103.7 |
| | | | crystalline | | | | | | | |
| 511 | Comparative | 55.3Fe—23.7Co—11.0B—2.0P—3.0Si—5.0Nb | Nano- | N/A | | 0.000 | 0.000 | — | — | — |
| | Example | | crystalline | | | | | | | |
| 512 | Example | 55.3Fe—23.7Co—11.0B—2.0P—3.0Si—5.0Nb | Nano- | 180 | 0.5 | 1.727 | 0.881 | 0.51 | 3.0 | 86.4 |
| | | | crystalline | | | | | | | |
| 513 | Example | 55.3Fe—23.7Co—11.0B—2.0P—3.0Si—5.0Nb | Nano- | 180 | 25 | 4.562 | 3.923 | 0.86 | 7.2 | 104.3 |
| | | | crystalline | | | | | | | |
| 514 | Comparative | 41.0Fe—41.0Co—11.0B—3.0P—3.0Si—1.0Cr | Amorphous | N/A | | 0.000 | 0.000 | — | — | — |
| | Example | | | | | | | | | |
| 515 | Example | 41.0Fe—41.0Co—11.0B—3.0P—3.0Si—1.0Cr | Amorphous | 180 | 0.5 | 1.768 | 0.849 | 0.48 | 3.0 | 85.9 |
| 516 | Example | 41.0Fe—41.0Co—11.0B—3.0P—3.0Si—1.0Cr | Amorphous | 180 | 25 | 4.638 | 3.942 | 0.85 | 7.3 | 104.5 |
| 517 | Comparative | 32.8Fe—49.2Co—11.0B—3.0P—3.0Si—1.0Cr | Amorphous | N/A | | 0.000 | 0.000 | — | — | — |
| | Example | | | | | | | | | |
| 518 | Example | 32.8Fe—49.2Co—11.0B—3.0P—3.0Si—1.0Cr | Amorphous | 180 | 0.5 | 1.753 | 0.859 | 0.49 | 3.1 | 86.9 |
| 519 | Example | 32.8Fe—49.2Co—11.0B—3.0P—3.0Si—1.0Cr | Amorphous | 180 | 25 | 4.785 | 4.020 | 0.84 | 7.5 | 105.0 |

According to Tables 10A to 10C, there was a similar tendency as in Experiment 9 despite the type and/or the microstructure of the powder being changed from those of Experiment 9.

### (Experiment 11)

The average particle size of the soft magnetic metal powder was changed from that of Sample Nos. 401, 433, and 437 of Experiment 9. Moreover, the treatment temperature of the oxide phase formation treatment was changed so that the smaller the average particle size of the soft magnetic metal powder, the smaller the T3 and T4. Other than that, Experiment 11 was conducted as in Experiment 9. Table 11 shows the results.

TABLE 11

| | | | Oxide phase | | | | | | |
|---|---|---|---|---|---|---|---|---|---|
| | | Powder | formation treatment | | | | | Rate of | Rate of |
| | | Average | | Water | | | | decrease in | increase in |
| | | particle | | amount | Oxide phase | | | relative | withstand |
| Sample | Example/ | size | Temperature | (parts by | T3 | T4 | | permeability | voltage |
| No. | Comparative Example | (μm) | (° C.) | mass) | (μm) | (μm) | T4/T3 | (%) | (%) |
| 520 | Comparative Example | 1.0 | N/A | | 0.000 | 0.000 | — | — | — |
| 521 | Example | 1.0 | 90 | 0.5 | 0.065 | 0.002 | 0.03 | 0.1 | 12.3 |
| 522 | Example | 1.0 | 90 | 30 | 0.097 | 0.052 | 0.54 | 0.3 | 26.4 |
| 523 | Comparative Example | 3.0 | N/A | | 0.000 | 0.000 | — | — | — |
| 524 | Example | 3.0 | 100 | 0.5 | 0.153 | 0.018 | 0.12 | 0.3 | 28.6 |
| 525 | Example | 3.0 | 100 | 30 | 0.297 | 0.187 | 0.63 | 0.8 | 50.0 |
| 526 | Comparative Example | 5.0 | N/A | | 0.000 | 0.000 | — | — | — |
| 527 | Example | 5.0 | 120 | 0.5 | 0.206 | 0.047 | 0.23 | 0.4 | 38.4 |
| 528 | Example | 5.0 | 120 | 30 | 0.700 | 0.503 | 0.74 | 1.7 | 64.2 |
| 529 | Comparative Example | 10 | N/A | | 0.000 | 0.000 | — | — | — |
| 530 | Example | 10 | 130 | 0.5 | 0.486 | 0.156 | 0.32 | 1.1 | 53.2 |
| 531 | Example | 10 | 130 | 30 | 1.284 | 1.002 | 0.78 | 2.8 | 76.6 |
| 401 | Comparative Example | 25 | N/A | | 0.000 | 0.000 | — | — | — |
| 433 | Example | 25 | 180 | 0.5 | 2.000 | 0.900 | 0.45 | 3.2 | 78.5 |
| 437 | Example | 25 | 180 | 25 | 5.585 | 4.747 | 0.85 | 8.5 | 97.8 |
| 532 | Comparative Example | 50 | N/A | | 0.000 | 0.000 | — | — | — |
| 533 | Example | 50 | 180 | 0.5 | 1.995 | 0.858 | 0.43 | 3.1 | 78.9 |
| 534 | Example | 50 | 180 | 25 | 5.572 | 4.625 | 0.83 | 8.2 | 97.1 |

According to Table 11, there was a similar tendency as in Experiment 9 despite the average particle size of the powder being changed from that of Experiment 9.

### (Experiment 12)

A coating film formation treatment was performed to the soft magnetic metal powder of Sample Nos. 401, 433, and 437 using a mechanofusion system (AMS-Lab manufactured by HOSOKAWA MICRON CORPORATION) to form a P—Zn—Al—O based oxide glass coating film on surfaces of the soft magnetic metal powder. The coating film had a thickness of about 3 nm. Other than that, Sample Nos. 535 to 537 were carried out as in Experiment 9. Table 12 shows the results.

The type of the coating film of the soft magnetic metal powder was changed from that of Sample Nos. 535 to 537. Table 12 shows types of the coating film. Samples whose coating film was a P—Zn—Al—Na—O based oxide glass coating film, a P—Zn—Al—Ca—O based oxide glass coating film, a Bi—Zn—B—Si—O based oxide glass coating film, or a Ba—Zn—B—Si—Al—O based oxide glass coating film were carried out as in Sample Nos. 535 to 537. For samples whose coating film was a phosphate film, a phosphate treatment was appropriately performed to the soft magnetic metal powder of Sample Nos. 401, 433, and 437. For samples whose coating film was a SiO₂ film, a silane coupling treatment was appropriately performed to the soft magnetic metal powder of Sample Nos. 401, 433, and 437. Table 12 shows the results.

TABLE 12

| | | | Oxide phase | | | | | | |
|---|---|---|---|---|---|---|---|---|---|
| | | | formation treatment | | | | | Rate of | Rate of |
| | | | | Water | | | | decrease in | increase in |
| | | | | amount | Oxide phase | | | relative | withstand |
| Sample | Example/ | Coating film | Temperature | (parts by | T3 | T4 | | permeability | voltage |
| No. | Comparative Example | Composition | (° C.) | mass) | (μm) | (μm) | T4/T3 | (%) | (%) |
| 401 | Comparative Example | N/A | N/A | | 0.000 | 0.000 | — | — | — |
| 433 | Example | N/A | 180 | 0.5 | 2.000 | 0.900 | 0.45 | 3.2 | 78.5 |
| 437 | Example | N/A | 180 | 25 | 5.585 | 4.747 | 0.85 | 8.5 | 97.8 |
| 535 | Comparative Example | P—Zn—Al—O | N/A | | 0.000 | 0.000 | — | — | — |
| 536 | Example | P—Zn—Al—O | 180 | 0.5 | 2.014 | 0.866 | 0.43 | 3.3 | 78.4 |
| 537 | Example | P—Zn—Al—O | 180 | 25 | 5.601 | 4.705 | 0.84 | 8.6 | 97.5 |
| 538 | Comparative Example | P—Zn—Al—Na—O | N/A | | 0.000 | 0.000 | — | — | — |
| 539 | Example | P—Zn—Al—Na—O | 180 | 0.5 | 2.012 | 0.885 | 0.44 | 3.2 | 78.5 |
| 540 | Example | P—Zn—Al—Na—O | 180 | 25 | 5.598 | 4.758 | 0.85 | 8.5 | 98.0 |
| 541 | Comparative Example | P—Zn—Al—Ca—O | N/A | | 0.000 | 0.000 | — | — | — |
| 542 | Example | P—Zn—Al—Ca—O | 180 | 0.5 | 2.019 | 0.909 | 0.45 | 3.4 | 79.3 |
| 543 | Example | P—Zn—Al—Ca—O | 180 | 25 | 5.600 | 4.648 | 0.83 | 8.6 | 97.3 |
| 544 | Comparative Example | Bi—Zn—B—Si—O | N/A | | 0.000 | 0.000 | — | — | — |
| 545 | Example | Bi—Zn—B—Si—O | 180 | 0.5 | 2.020 | 0.889 | 0.44 | 3.4 | 78.8 |
| 546 | Example | Bi—Zn—B—Si—O | 180 | 25 | 5.595 | 4.700 | 0.84 | 8.6 | 97.5 |
| 547 | Comparative Example | Ba—Zn—B—Si—Al—O | N/A | | 0.000 | 0.000 | — | — | — |
| 548 | Example | Ba—Zn—B—Si—Al—O | 180 | 0.5 | 2.015 | 0.887 | 0.44 | 3.3 | 78.5 |
| 549 | Example | Ba—Zn—B—Si—Al—O | 180 | 25 | 5.606 | 4.653 | 0.83 | 8.7 | 97.5 |
| 550 | Comparative Example | Phosphate film | N/A | | 0.000 | 0.000 | — | — | — |
| 551 | Example | Phosphate film | 180 | 0.5 | 2.014 | 0.846 | 0.42 | 3.2 | 78.4 |
| 552 | Example | Phosphate film | 180 | 25 | 5.601 | 4.705 | 0.84 | 8.6 | 97.8 |
| 553 | Comparative Example | SiO₂ film | N/A | | 0.000 | 0.000 | — | — | — |
| 554 | Example | SiO₂ film | 180 | 0.5 | 2.022 | 0.910 | 0.45 | 3.2 | 79.4 |
| 555 | Example | SiO₂ film | 180 | 25 | 5.594 | 4.755 | 0.85 | 8.5 | 98.3 |

According to Table 12, there was a similar tendency as in Experiment 9 despite the type of the coating film of the soft magnetic metal powder being changed. Note that, when only formation of the coating film was performed and the oxide phase formation treatment was not performed, the magnetic core did not include the specific particles including the oxide phases having an average thickness of 0.005 μm or more. This was because, as described above, the coating film had a thickness of about 3 nm (0.003 μm). Table 12 shows T3=T4=0.000 for samples in which the oxide phase formation treatment was not performed, for the sake of convenience.

Also, in each Example shown in Table 12, in the specific particles resulting from the oxide phase formation treatment to the soft magnetic metal powder with the coating film, no boundaries were confirmed between the coating film and the oxide phase formed with the oxide phase formation treatment.

### (Experiment 13)

The soft magnetic metal powder having an average particle size of 25 μm used in Experiment 9 was defined as a powder D. A soft magnetic metal powder that was prepared under the same conditions as those of the powder D except that the average particle size was 3.0 μm was defined as a powder E. A soft magnetic metal powder that was prepared under the same conditions as those of the powder D except that the average particle size was 0.8 μm was defined as a powder F. The powders D to F were mixed at a ratio shown in Table 13 to provide a mixed powder.

Experiment 13 was conducted as in Sample Nos. 401 and 437 of Experiment 9 except that the mixed powder was used. Table 13 shows the results.

TABLE 13

| | | | | | | | | Oxide phase | | | | | | |
|---|---|---|---|---|---|---|---|---|---|---|---|---|---|---|
| | | Powder | | | | | | formation treatment | | | | | Rate of | Rate of |
| | | Average particle size | | | Mix ratio | | | | Water | | | | decrease in | increase in |
| Sam- | Example/ | (μm) | | | (mass %) | | | Temper- | amount | Oxide phase | | | relative | withstand |
| ple | Comparative | Powder | Powder | Powder | Powder | Powder | Powder | ature | (parts by | T3 | T4 | T4/ | permeability | voltage |
| No. | Example | D | E | F | D | E | F | (° C.) | mass) | (μm) | (μm) | T3 | (%) | (%) |
| 401 | Comparative | 25.0 | 3.0 | 0.8 | 100 | 0 | 0 | N/A | | 0.000 | 0.000 | — | — | — |
| | Example | | | | | | | | | | | | | |
| 437 | Example | 25.0 | 3.0 | 0.8 | 100 | 0 | 0 | 180 | 25 | 5.585 | 4.747 | 0.85 | 8.5 | 97.8 |
| 556 | Comparative | 25.0 | 3.0 | 0.8 | 90 | 5 | 5 | N/A | | 0.000 | 0.000 | — | — | — |
| | Example | | | | | | | | | | | | | |
| 557 | Example | 25.0 | 3.0 | 0.8 | 90 | 5 | 5 | 180 | 25 | 5.587 | 4.749 | 0.85 | 8.4 | 98.1 |
| 558 | Comparative | 25.0 | 3.0 | 0.8 | 80 | 10 | 10 | N/A | | 0.000 | 0.000 | — | — | — |
| | Example | | | | | | | | | | | | | |
| 559 | Example | 25.0 | 3.0 | 0.8 | 80 | 10 | 10 | 180 | 25 | 5.593 | 4.698 | 0.84 | 8.5 | 97.6 |
| 560 | Comparative | 25.0 | 3.0 | 0.8 | 50 | 25 | 25 | N/A | | 0.000 | 0.000 | — | — | — |
| | Example | | | | | | | | | | | | | |
| 561 | Example | 25.0 | 3.0 | 0.8 | 50 | 25 | 25 | 180 | 25 | 5.697 | 4.785 | 0.84 | 8.6 | 98.8 |
| 562 | Comparative | 25.0 | 3.0 | 0.8 | 30 | 35 | 35 | N/A | | 0.000 | 0.000 | — | — | — |
| | Example | | | | | | | | | | | | | |
| 563 | Example | 25.0 | 3.0 | 0.8 | 30 | 35 | 35 | 180 | 25 | 5.600 | 4.704 | 0.84 | 8.5 | 97.8 |

According to Table 13, there was a similar tendency as in Experiment 9 despite multiple types of powders with different average particle sizes being mixed.

### (Experiment 14)

Experiment 14 was conducted as in Sample Nos. 558 and 559 of Experiment 13 except that the composition of at least one of the powders D to F was changed to a composition shown in Table 14A. Note that the powder D of Sample Nos. 568, 569, 574, and 575; the powder E of Sample Nos. 580, 581, 586, and 587; and the powder F of Sample Nos. 592, 593, 598, and 599 were heat treated after being prepared using the gas atomization method to deposit nanocrystals with a crystallite size of 30 nm or less. The heat treatment was performed specifically at 400° C. to 650° C. for 10 to 60 minutes. Using XRD, it was confirmed that each powder had a microstructure shown in Table 14A. Tables 14A and 14B show the results.

TABLE 14A

| Sam- | | Powder | | |
|---|---|---|---|---|
| ple | Example/ | Powder D | | Powder E |
| No. | Comparative Example | Composition (atomic ratio) | Microstructure | Composition (atomic ratio) |
| 558 | Comparative Example | Fe | Crystalline | Fe |
| 559 | Example | Fe | Crystalline | Fe |
| 564 | Comparative Example | 90.0Fe—10.0Si | Crystalline | Fe |
| 565 | Example | 90.0Fe—10.0Si | Crystalline | Fe |
| 566 | Comparative Example | 81.6Fe—13.4B—3.4Si—1.6C | Amorphous | Fe |
| 567 | Example | 81.6Fe—13.4B—3.4Si—1.6C | Amorphous | Fe |
| 568 | Comparative Example | 73.5Fe—13.5Si—9.0B—3.0Nb—1.0Cu | Nanocrystalline | Fe |
| 569 | Example | 73.5Fe—13.5Si—9.0B—3.0Nb—1.0Cu | Nanocrystalline | Fe |
| 570 | Comparative Example | 80.5Fe—9.0Co—8.5Si—2.0Cr | Crystalline | Fe |
| 571 | Example | 80.5Fe—9.0Co—8.5Si—2.0Cr | Crystalline | Fe |
| 572 | Comparative Example | 57.4Fe—24.6Co—11.0B—3.0P—3.0Si—1.0Cr | Amorphous | Fe |
| 573 | Example | 57.4Fe—24.6Co—11.0B—3.0P—3.0Si—1.0Cr | Amorphous | Fe |
| 574 | Comparative Example | 55.3Fe—23.7Co—11.0B—2.0P—3.0Si—5.0Nb | Nanocrystalline | Fe |
| 575 | Example | 55.3Fe—23.7Co—11.0B—2.0P—3.0Si—5.0Nb | Nanocrystalline | Fe |
| 576 | Comparative Example | Fe | Crystalline | 90.0Fe—10.0Si |
| 577 | Example | Fe | Crystalline | 90.0Fe—10.0Si |
| 578 | Comparative Example | Fe | Crystalline | 81.6Fe—13.4B—3.4Si—1.6C |
| 579 | Example | Fe | Crystalline | 81.6Fe—13.4B—3.4Si—1.6C |
| 580 | Comparative Example | Fe | Crystalline | 73.5Fe—13.5Si—9.0B—3.0Nb—1.0Cu |
| 581 | Example | Fe | Crystalline | 73.5Fe—13.5Si—9.0B—3.0Nb—1.0Cu |
| 582 | Comparative Example | Fe | Crystalline | 80.5Fe—9.0Co—8.5Si—2.0Cr |
| 583 | Example | Fe | Crystalline | 80.5Fe—9.0Co—8.5Si—2.0Cr |
| 584 | Comparative Example | Fe | Crystalline | 57.4Fe—24.6Co—11.0B—3.0P—3.0Si—1.0Cr |
| 585 | Example | Fe | Crystalline | 57.4Fe—24.6Co—11.0B—3.0P—3.0Si—1.0Cr |
| 586 | Comparative Example | Fe | Crystalline | 55.3Fe—23.7Co—11.0B—2.0P—3.0Si—5.0Nb |
| 587 | Example | Fe | Crystalline | 55.3Fe—23.7Co—11.0B—2.0P—3.0Si—5.0Nb |
| 588 | Comparative Example | Fe | Crystalline | Fe |
| 589 | Example | Fe | Crystalline | Fe |
| 590 | Comparative Example | Fe | Crystalline | Fe |
| 591 | Example | Fe | Crystalline | Fe |
| 592 | Comparative Example | Fe | Crystalline | Fe |
| 593 | Example | Fe | Crystalline | Fe |
| 594 | Comparative Example | Fe | Crystalline | Fe |
| 595 | Example | Fe | Crystalline | Fe |
| 596 | Comparative Example | Fe | Crystalline | Fe |
| 597 | Example | Fe | Crystalline | Fe |
| 598 | Comparative Example | Fe | Crystalline | Fe |
| 599 | Example | Fe | Crystalline | Fe |
| 600 | Comparative Example | 57.4Fe—24.6Co—11.0B—3.0P—3.0Si—1.0Cr | Amorphous | 57.4Fe—24.6Co—11.0B—3.0P—3.0Si—1.0Cr |
| 601 | Example | 57.4Fe—24.6Co—11.0B—3.0P—3.0Si—1.0Cr | Amorphous | 57.4Fe—24.6Co—11.0B—3.0P—3.0Si—1.0Cr |
| 602 | Comparative Example | Fe | Crystalline | 57.4Fe—24.6Co—11.0B—3.0P—3.0Si—1.0Cr |
| 603 | Example | Fe | Crystalline | 57.4Fe—24.6Co—11.0B—3.0P—3.0Si—1.0Cr |
| 604 | Comparative Example | 57.4Fe—24.6Co—11.0B—3.0P—3.0Si—1.0Cr | Amorphous | 57.4Fe—24.6Co—11.0B—3.0P—3.0Si—1.0Cr |
| 605 | Example | 57.4Fe—24.6Co—11.0B—3.0P—3.0Si—1.0Cr | Amorphous | 57.4Fe—24.6Co—11.0B—3.0P—3.0Si—1.0Cr |

| Sam- | Powder | | |
|---|---|---|---|
| ple | Powder E | Powder F | |
| No. | Microstructure | Composition (atomic ratio) | Microstructure |
| 558 | Crystalline | Fe | Crystalline |
| 559 | Crystalline | Fe | Crystalline |
| 564 | Crystalline | Fe | Crystalline |
| 565 | Crystalline | Fe | Crystalline |
| 566 | Crystalline | Fe | Crystalline |
| 567 | Crystalline | Fe | Crystalline |
| 568 | Crystalline | Fe | Crystalline |
| 569 | Crystalline | Fe | Crystalline |
| 570 | Crystalline | Fe | Crystalline |
| 571 | Crystalline | Fe | Crystalline |
| 572 | Crystalline | Fe | Crystalline |
| 573 | Crystalline | Fe | Crystalline |
| 574 | Crystalline | Fe | Crystalline |
| 575 | Crystalline | Fe | Crystalline |
| 576 | Crystalline | Fe | Crystalline |
| 577 | Crystalline | Fe | Crystalline |
| 578 | Amorphous | Fe | Crystalline |
| 579 | Amorphous | Fe | Crystalline |
| 580 | Nanocrystalline | Fe | Crystalline |
| 581 | Nanocrystalline | Fe | Crystalline |
| 582 | Crystalline | Fe | Crystalline |
| 583 | Crystalline | Fe | Crystalline |
| 584 | Amorphous | Fe | Crystalline |
| 585 | Amorphous | Fe | Crystalline |
| 586 | Nanocrystalline | Fe | Crystalline |
| 587 | Nanocrystalline | Fe | Crystalline |
| 588 | Crystalline | 90.0Fe—10.0Si | Crystalline |
| 589 | Crystalline | 90.0Fe—10.0Si | Crystalline |
| 590 | Crystalline | 81.6Fe—13.4B—3.4Si—1.6C | Amorphous |
| 591 | Crystalline | 81.6Fe—13.4B—3.4Si—1.6C | Amorphous |
| 592 | Crystalline | 73.5Fe—13.5Si—9.0B—3.0Nb—1.0Cu | Nanocrystalline |
| 593 | Crystalline | 73.5Fe—13.5Si—9.0B—3.0Nb—1.0Cu | Nanocrystalline |
| 594 | Crystalline | 80.5Fe—9.0Co—8.5Si—2.0Cr | Crystalline |
| 595 | Crystalline | 80.5Fe—9.0Co—8.5Si—2.0Cr | Crystalline |
| 596 | Crystalline | 57.4Fe—24.6Co—11.0B—3.0P—3.0Si—1.0Cr | Amorphous |
| 597 | Crystalline | 57.4Fe—24.6Co—11.0B—3.0P—3.0Si—1.0Cr | Amorphous |
| 598 | Crystalline | 55.3Fe—23.7Co—11.0B—2.0P—3.0Si—5.0Nb | Nanocrystalline |
| 599 | Crystalline | 55.3Fe—23.7Co—11.0B—2.0P—3.0Si—5.0Nb | Nanocrystalline |
| 600 | Amorphous | Fe | Crystalline |
| 601 | Amorphous | Fe | Crystalline |
| 602 | Amorphous | 57.4Fe—24.6Co—11.0B—3.0P—3.0Si—1.0Cr | Amorphous |
| 603 | Amorphous | 57.4Fe—24.6Co—11.0B—3.0P—3.0Si—1.0Cr | Amorphous |
| 604 | Amorphous | 57.4Fe—24.6Co—11.0B—3.0P—3.0Si—1.0Cr | Amorphous |
| 605 | Amorphous | 57.4Fe—24.6Co—11.0B—3.0P—3.0Si—1.0Cr | Amorphous |

TABLE 14B

| | | Oxide phase | | | | | | |
|---|---|---|---|---|---|---|---|---|
| | | formation treatment | | | | | Rate of | Rate of |
| | | | Water | | | | decrease in | increase in |
| | | | amount | Oxide phase | | | relative | withstand |
| Sample | Example/ | Temperature | (parts by | T3 | T4 | | permeability | voltage |
| No. | Comparative Example | (° C.) | mass) | (μm) | (μm) | T4/T3 | (%) | (%) |
| 558 | Comparative Example | N/A | | 0.000 | 0.000 | — | — | — |
| 559 | Example | 180 | 25 | 5.593 | 4.698 | 0.84 | 8.5 | 97.6 |
| 564 | Comparative Example | N/A | | 0.000 | 0.000 | — | — | — |
| 565 | Example | 180 | 25 | 5.213 | 4.327 | 0.83 | 7.7 | 94.7 |
| 566 | Comparative Example | N/A | | 0.000 | 0.000 | — | — | — |
| 567 | Example | 180 | 25 | 4.871 | 4.043 | 0.83 | 7.4 | 94.1 |
| 568 | Comparative Example | N/A | | 0.000 | 0.000 | — | — | — |
| 569 | Example | 180 | 25 | 4.485 | 3.633 | 0.81 | 6.9 | 92.8 |
| 570 | Comparative Example | N/A | | 0.000 | 0.000 | — | — | — |
| 571 | Example | 180 | 25 | 5.249 | 4.409 | 0.84 | 7.8 | 102.9 |
| 572 | Comparative Example | N/A | | 0.000 | 0.000 | — | — | — |
| 573 | Example | 180 | 25 | 4.855 | 4.030 | 0.83 | 7.3 | 102.0 |
| 574 | Comparative Example | N/A | | 0.000 | 0.000 | — | — | — |
| 575 | Example | 180 | 25 | 4.767 | 3.909 | 0.82 | 7.2 | 101.6 |
| 576 | Comparative Example | N/A | | 0.000 | 0.000 | — | — | — |
| 577 | Example | 180 | 25 | 5.539 | 4.708 | 0.85 | 8.4 | 97.2 |
| 578 | Comparative Example | N/A | | 0.000 | 0.000 | — | — | — |
| 579 | Example | 180 | 25 | 5.496 | 4.672 | 0.85 | 8.3 | 96.5 |
| 580 | Comparative Example | N/A | | 0.000 | 0.000 | — | — | — |
| 581 | Example | 180 | 25 | 5.448 | 4.631 | 0.85 | 8.2 | 96.2 |
| 582 | Comparative Example | N/A | | 0.000 | 0.000 | — | — | — |
| 583 | Example | 180 | 25 | 5.543 | 4.712 | 0.85 | 8.4 | 100.2 |
| 584 | Comparative Example | N/A | | 0.000 | 0.000 | — | — | — |
| 585 | Example | 180 | 25 | 5.494 | 4.670 | 0.85 | 8.3 | 99.8 |
| 586 | Comparative Example | N/A | | 0.000 | 0.000 | — | — | — |
| 587 | Example | 180 | 25 | 5.483 | 4.661 | 0.85 | 8.3 | 99.6 |
| 588 | Comparative Example | N/A | | 0.000 | 0.000 | — | — | — |
| 589 | Example | 180 | 25 | 5.562 | 4.728 | 0.85 | 8.4 | 97.5 |
| 590 | Comparative Example | N/A | | 0.000 | 0.000 | — | — | — |
| 591 | Example | 180 | 25 | 5.540 | 4.709 | 0.85 | 8.3 | 97.4 |
| 592 | Comparative Example | N/A | | 0.000 | 0.000 | — | — | — |
| 593 | Example | 180 | 25 | 5.516 | 4.689 | 0.85 | 8.2 | 97.3 |
| 594 | Comparative Example | N/A | | 0.000 | 0.000 | — | — | — |
| 595 | Example | 180 | 25 | 5.564 | 4.729 | 0.85 | 8.4 | 98.6 |
| 596 | Comparative Example | N/A | | 0.000 | 0.000 | — | — | — |
| 597 | Example | 180 | 25 | 5.539 | 4.708 | 0.85 | 8.3 | 98.4 |
| 598 | Comparative Example | N/A | | 0.000 | 0.000 | — | — | — |
| 599 | Example | 180 | 25 | 5.534 | 4.704 | 0.85 | 8.3 | 98.2 |
| 600 | Comparative Example | N/A | | 0.000 | 0.000 | — | — | — |
| 601 | Example | 180 | 25 | 4.718 | 3.916 | 0.83 | 7.1 | 103.0 |
| 602 | Comparative Example | N/A | | 0.000 | 0.000 | — | — | — |
| 603 | Example | 180 | 25 | 5.402 | 4.592 | 0.85 | 8.0 | 101.6 |
| 604 | Comparative Example | N/A | | 0.000 | 0.000 | — | — | — |
| 605 | Example | 180 | 25 | 4.672 | 3.878 | 0.83 | 7.1 | 104.5 |

According to Tables 14A and 14B, there was a similar tendency as in Experiment 13 despite the composition and the microstructure of the powders being changed.

### (Experiment 15)

Sample Nos. 606 to 609 were carried out as in Sample Nos. 401 and 437 of Experiment 11 except that the powder was partly replaced with a powder that was prepared similarly to the original powder but had an average particle size of 1.0 μm. Sample Nos. 610 to 613 were carried out as in Sample Nos. 529 and 531 of Experiment 11 except that the powder was partly replaced with a powder that was prepared similarly to the original powder but had an average particle size of 1.0 μm. Sample Nos. 614 to 617 were carried out as in Sample Nos. 526 and 528 of Experiment 11 except that the powder was partly replaced with a powder that was prepared similarly to the original powder but had an average particle size of 1.0 μm. Table 15 shows the results.

TABLE 15

| | | | | | | Oxide phase | | | | | | |
|---|---|---|---|---|---|---|---|---|---|---|---|---|
| | | Powder | | | | formation treatment | | | | | Rate of | Rate of |
| | | Average particle size | | Mix ratio | | | Water | | | | decrease in | increase in |
| Sam- | | (μm) | | (mass %) | | Temper- | amount | Oxide phase | | | relative | withstand |
| ple | Example/ | Powder | Powder | Powder | Powder | ature | (parts by | T3 | T4 | T4/ | permeability | voltage |
| No. | Comparative Example | D | E | D | E | (° C.) | mass) | (μm) | (μm) | T3 | (%) | (%) |
| 401 | Comparative Example | 25 | 1.0 | 100 | 0 | N/A | | 0.000 | 0.000 | — | — | — |
| 437 | Example | 25 | 1.0 | 100 | 0 | 180 | 25 | 5.585 | 4.747 | 0.85 | 8.5 | 97.8 |
| 606 | Comparative Example | 25 | 1.0 | 80 | 20 | N/A | | 0.000 | 0.000 | — | — | — |
| 607 | Example | 25 | 1.0 | 80 | 20 | 180 | 25 | 5.500 | 4.675 | 0.85 | 8.4 | 95.6 |
| 608 | Comparative Example | 25 | 1.0 | 50 | 50 | N/A | | 0.000 | 0.000 | — | — | — |
| 609 | Example | 25 | 1.0 | 50 | 50 | 180 | 25 | 5.482 | 4.605 | 0.84 | 8.3 | 94.5 |
| 529 | Comparative Example | 10 | 1.0 | 100 | 0 | N/A | | 0.000 | 0.000 | — | — | — |
| 531 | Example | 10 | 1.0 | 100 | 0 | 130 | 30 | 1.284 | 1.002 | 0.78 | 2.8 | 76.6 |
| 610 | Comparative Example | 10 | 1.0 | 80 | 20 | N/A | | 0.000 | 0.000 | — | — | — |
| 611 | Example | 10 | 1.0 | 80 | 20 | 130 | 30 | 1.215 | 0.948 | 0.78 | 2.7 | 74.7 |
| 612 | Comparative Example | 10 | 1.0 | 50 | 50 | N/A | | 0.000 | 0.000 | — | — | — |
| 613 | Example | 10 | 1.0 | 50 | 50 | 130 | 30 | 1.187 | 0.926 | 0.78 | 2.6 | 73.8 |
| 526 | Comparative Example | 5.0 | 1.0 | 100 | 0 | N/A | | 0.000 | 0.000 | — | — | — |
| 528 | Example | 5.0 | 1.0 | 100 | 0 | 120 | 30 | 0.700 | 0.503 | 0.74 | 1.7 | 64.2 |
| 614 | Comparative Example | 5.0 | 1.0 | 80 | 20 | N/A | | 0.000 | 0.000 | — | — | — |
| 615 | Example | 5.0 | 1.0 | 80 | 20 | 120 | 30 | 0.621 | 0.460 | 0.74 | 1.5 | 62.4 |
| 616 | Comparative Example | 5.0 | 1.0 | 50 | 50 | N/A | | 0.000 | 0.000 | — | — | — |
| 617 | Example | 5.0 | 1.0 | 50 | 50 | 120 | 30 | 0.602 | 0.445 | 0.74 | 1.5 | 61.8 |

According to Table 15, there was a similar tendency as in Experiment 11 despite multiple types of powders with different average particle sizes being mixed.

### (Experiment 16)

With the treatment temperature and the treatment time of the oxide phase formation treatment being changed from those of Sample No. 437 of Experiment 9 so as not to substantially change T3 or T4 therefrom, Sample Nos. 701 and 702 were carried out. Further, Co/α and P/α of the oxide phases of each sample were measured using SEM-EDS. Table 16 shows the results.

With the treatment temperature and the treatment time of the oxide phase formation treatment being changed from those of Sample No. 489 of Experiment 10 so as not to substantially change T3 or T4 therefrom, Sample Nos. 703 and 704 were carried out. Further, Co/α and P/α of the oxide phases of each sample were measured using SEM-EDS. Table 16 shows the results.

With the treatment temperature and the treatment time of the oxide phase formation treatment being changed from those of Sample No. 507 of Experiment 10 so as not to substantially change T3 or T4 therefrom, Sample Nos. 705 to 712 were carried out. Further, Co/α and P/α of the oxide phases of each sample were measured using SEM-EDS. Table 16 shows the results.

With the treatment temperature and the treatment time of the oxide phase formation treatment being changed from those of Sample No. 516 of Experiment 10 so as not to substantially change T3 or T4 therefrom, Sample Nos. 713 to 720 were carried out. Further, Co/α and P/α of the oxide phases of each sample were measured using SEM-EDS. Table 16 shows the results.

With the treatment temperature and the treatment time of the oxide phase formation treatment being changed from those of Sample No. 519 of Experiment 10 so as not to substantially change T3 or T4 therefrom, Sample Nos. 721 to 728 were carried out. Further, Co/α and P/α of the oxide phases of each sample were measured using SEM-EDS. Table 16 shows the results.

TABLE 16

| | | | Oxide phase | | |
|---|---|---|---|---|---|
| | | Powder | formation treatment | | |
| Sample | Example/ | Composition | Temperature | Water amount | Time |
| No. | Comparative Example | (atomic ratio) | (° C.) | (parts by mass) | (min) |
| 401 | Comparative Example | 100.0Fe | N/A | | |
| 701 | Example | 100.0Fe | 80 | 25 | 300 |
| 437 | Example | 100.0Fe | 180 | 25 | 60 |
| 702 | Example | 100.0Fe | 250 | 25 | 10 |
| 487 | Comparative Example | 50.0Fe—50.0Co | N/A | | |
| 703 | Example | 50.0Fe—50.0Co | 80 | 25 | 300 |
| 489 | Example | 50.0Fe—50.0Co | 180 | 25 | 60 |
| 704 | Example | 50.0Fe—50.0Co | 250 | 25 | 10 |
| 505 | Comparative Example | 57.4Fe—24.6Co—11.0B—3.0P—3.0Si—1.0Cr | N/A | | |
| 705 | Example | 57.4Fe—24.6Co—11.0B—3.0P—3.0Si—1.0Cr | 80 | 25 | 300 |
| 706 | Example | 57.4Fe—24.6Co—11.0B—3.0P—3.0Si—1.0Cr | 90 | 25 | 250 |
| 707 | Example | 57.4Fe—24.6Co—11.0B—3.0P—3.0Si—1.0Cr | 100 | 25 | 200 |
| 708 | Example | 57.4Fe—24.6Co—11.0B—3.0P—3.0Si—1.0Cr | 120 | 25 | 180 |
| 709 | Example | 57.4Fe—24.6Co—11.0B—3.0P—3.0Si—1.0Cr | 130 | 25 | 150 |
| 710 | Example | 57.4Fe—24.6Co—11.0B—3.0P—3.0Si—1.0Cr | 150 | 25 | 100 |
| 507 | Example | 57.4Fe—24.6Co—11.0B—3.0P—3.0Si—1.0Cr | 180 | 25 | 60 |
| 711 | Example | 57.4Fe—24.6Co—11.0B—3.0P—3.0Si—1.0Cr | 200 | 25 | 30 |
| 712 | Example | 57.4Fe—24.6Co—11.0B—3.0P—3.0Si—1.0Cr | 250 | 25 | 20 |
| 514 | Comparative Example | 41.0Fe—41.0Co—11.0B—3.0P—3.0Si—1.0Cr | N/A | | |
| 713 | Example | 41.0Fe—41.0Co—11.0B—3.0P—3.0Si—1.0Cr | 80 | 25 | 300 |
| 714 | Example | 41.0Fe—41.0Co—11.0B—3.0P—3.0Si—1.0Cr | 90 | 25 | 250 |
| 715 | Example | 41.0Fe—41.0Co—11.0B—3.0P—3.0Si—1.0Cr | 100 | 25 | 200 |
| 716 | Example | 41.0Fe—41.0Co—11.0B—3.0P—3.0Si—1.0Cr | 120 | 25 | 180 |
| 717 | Example | 41.0Fe—41.0Co—11.0B—3.0P—3.0Si—1.0Cr | 130 | 25 | 150 |
| 718 | Example | 41.0Fe—41.0Co—11.0B—3.0P—3.0Si—1.0Cr | 150 | 25 | 100 |
| 516 | Example | 41.0Fe—41.0Co—11.0B—3.0P—3.0Si—1.0Cr | 180 | 25 | 60 |
| 719 | Example | 41.0Fe—41.0Co—11.0B—3.0P—3.0Si—1.0Cr | 200 | 25 | 30 |
| 720 | Example | 41.0Fe—41.0Co—11.0B—3.0P—3.0Si—1.0Cr | 250 | 25 | 20 |
| 517 | Comparative Example | 32.8Fe—49.2Co—11.0B—3.0P—3.0Si—1.0Cr | N/A | | |
| 721 | Example | 32.8Fe—49.2Co—11.0B—3.0P—3.0Si—1.0Cr | 80 | 25 | 300 |
| 722 | Example | 32.8Fe—49.2Co—11.0B—3.0P—3.0Si—1.0Cr | 90 | 25 | 250 |
| 723 | Example | 32.8Fe—49.2Co—11.0B—3.0P—3.0Si—1.0Cr | 100 | 25 | 200 |
| 724 | Example | 32.8Fe—49.2Co—11.0B—3.0P—3.0Si—1.0Cr | 120 | 25 | 180 |
| 725 | Example | 32.8Fe—49.2Co—11.0B—3.0P—3.0Si—1.0Cr | 130 | 25 | 150 |
| 726 | Example | 32.8Fe—49.2Co—11.0B—3.0P—3.0Si—1.0Cr | 150 | 25 | 100 |
| 519 | Example | 32.8Fe—49.2Co—11.0B—3.0P—3.0Si—1.0Cr | 180 | 25 | 60 |
| 727 | Example | 32.8Fe—49.2Co—11.0B—3.0P—3.0Si—1.0Cr | 200 | 25 | 30 |
| 728 | Example | 32.8Fe—49.2Co—11.0B—3.0P—3.0Si—1.0Cr | 250 | 25 | 20 |

| | | | | | | Rate of | Rate of |
|---|---|---|---|---|---|---|---|
| | | | | | | decrease in | increase in |
| | Oxide phase | | | | | relative | withstand |
| Sample | T3 | T4 | | | | permeability | voltage |
| No. | (μm) | (μm) | T4/T3 | Co/α | P/α | (%) | (%) |
| 401 | 0.000 | 0.000 | — | — | — | — | — |
| 701 | 5.591 | 4.696 | 0.84 | 0.00 | 0.00 | 8.5 | 97.8 |
| 437 | 5.585 | 4.747 | 0.85 | 0.00 | 0.00 | 8.5 | 97.8 |
| 702 | 5.579 | 4.742 | 0.85 | 0.00 | 0.00 | 8.5 | 98.1 |
| 487 | 0.000 | 0.000 | — | — | — | — | — |
| 703 | 5.604 | 4.764 | 0.85 | 0.25 | 0.00 | 8.4 | 106.8 |
| 489 | 5.609 | 4.768 | 0.85 | 0.49 | 0.00 | 8.4 | 107.3 |
| 704 | 5.610 | 4.712 | 0.84 | 0.70 | 0.00 | 8.4 | 107.1 |
| 505 | 0.000 | 0.000 | — | — | — | — | — |
| 705 | 4.674 | 3.926 | 0.84 | 0.18 | 0.47 | 7.3 | 130.1 |
| 706 | 4.667 | 3.874 | 0.83 | 0.19 | 0.45 | 7.3 | 127.2 |
| 707 | 4.671 | 3.924 | 0.84 | 0.20 | 0.40 | 7.3 | 124.4 |
| 708 | 4.666 | 3.873 | 0.83 | 0.25 | 0.21 | 7.3 | 120.9 |
| 709 | 4.676 | 3.834 | 0.82 | 0.27 | 0.16 | 7.3 | 118.4 |
| 710 | 4.675 | 3.880 | 0.83 | 0.28 | 0.10 | 7.3 | 115.0 |
| 507 | 4.672 | 3.878 | 0.83 | 0.29 | 0.04 | 7.3 | 104.2 |
| 711 | 4.672 | 3.924 | 0.84 | 0.30 | 0.03 | 7.3 | 103.8 |
| 712 | 4.669 | 3.876 | 0.83 | 0.30 | 0.03 | 7.3 | 104.5 |
| 514 | 0.000 | 0.000 | — | — | — | — | — |
| 713 | 4.638 | 3.942 | 0.85 | 0.28 | 0.47 | 7.3 | 130.2 |
| 714 | 4.638 | 3.989 | 0.86 | 0.30 | 0.44 | 7.3 | 126.9 |
| 715 | 4.635 | 3.847 | 0.83 | 0.32 | 0.39 | 7.3 | 124.1 |
| 716 | 4.641 | 3.898 | 0.84 | 0.42 | 0.20 | 7.3 | 121.1 |
| 717 | 4.634 | 3.939 | 0.85 | 0.44 | 0.15 | 7.3 | 118.2 |
| 718 | 4.633 | 3.892 | 0.84 | 0.46 | 0.12 | 7.3 | 115.4 |
| 516 | 4.638 | 3.942 | 0.85 | 0.49 | 0.05 | 7.3 | 104.5 |
| 719 | 4.644 | 3.947 | 0.85 | 0.50 | 0.03 | 7.3 | 104.2 |
| 720 | 4.638 | 3.989 | 0.86 | 0.50 | 0.03 | 7.3 | 104.2 |
| 517 | 0.000 | 0.000 | — | — | — | — | — |
| 721 | 4.790 | 3.928 | 0.82 | 0.33 | 0.45 | 7.5 | 130.0 |
| 722 | 4.787 | 4.022 | 0.84 | 0.35 | 0.43 | 7.5 | 127.0 |
| 723 | 4.784 | 4.114 | 0.86 | 0.39 | 0.37 | 7.5 | 124.1 |
| 724 | 4.786 | 4.021 | 0.84 | 0.49 | 0.21 | 7.5 | 120.8 |
| 725 | 4.784 | 4.066 | 0.85 | 0.52 | 0.15 | 7.5 | 118.3 |
| 726 | 4.784 | 4.019 | 0.84 | 0.56 | 0.10 | 7.5 | 115.2 |
| 519 | 4.785 | 4.020 | 0.84 | 0.58 | 0.04 | 7.5 | 105.0 |
| 727 | 4.783 | 4.066 | 0.85 | 0.59 | 0.03 | 7.5 | 103.9 |
| 728 | 4.791 | 4.024 | 0.84 | 0.60 | 0.03 | 7.5 | 104.5 |

According to Table 16, there was a similar tendency as in Experiments 9 and 10 despite Co/α and P/α of the oxide phases being changed without T3 or T4 substantially being changed.

In all Examples of Experiments 9 to 16, it was confirmed that the magnetic core included a soft magnetic metal particle whose maximum-thickness portion was closer to a specific surface than its opposite maximum-thickness portion was. In this context, the specific surface was defined as a surface of the magnetic core closest to the soft magnetic metal particle including the oxide phase. It was also confirmed that, in all Examples of Experiments 9 to 16, in a cross-section of the magnetic core, the specific particles 111 satisfying 0<T4/T3≤0.98 in the surface portion accounted for a total area percentage of 1% or more and 85% or less of the area of the surface portion. It was also confirmed that, in all Examples of Experiments 9 to 16, the oxide phases of the specific particles in the central portion of the magnetic core had an average thickness of 0.5 μm or less, and the oxide phases of the specific particles in the surface portion had an average thickness larger than that of the oxide phases of the specific particles in the central portion.

### REFERENCE NUMERALS

1, 2 . . . magnetic core
3 . . . surface portion
4 . . . central portion
10 . . . soft magnetic metal particle
11, 111 . . . specific particle
11a, 111a . . . oxide phase
11b, 111b . . . particle body
13 . . . resin
21, 22 . . . outermost surface
21a . . . specific surface
101 . . . inscribed circle
101c . . . center
103 . . . specific straight line

What is claimed is:

1. A magnetic core comprising specific particles, wherein
the magnetic core comprises
a surface portion at a distance of 100 μm or less from an outermost surface of the magnetic core, and
a central portion at a distance of more than 100 μm from the outermost surface of the magnetic core,
the specific particles comprise soft magnetic metal particles including respective oxide phases with a thickness of 0.025 μm or more at surfaces of the soft magnetic metal particles,
at least the surface portion comprises the specific particles, and
T1≥0.050, T2≤0.500, and T1>T2 are satisfied, where
T1 [μm] denotes an average thickness of the oxide phases of the specific particles in the surface portion, and
T2 [μm] denotes an average thickness of the oxide phases of the specific particles in the central portion.

2. The magnetic core according to claim 1, wherein at least some of the specific particles comprise Fe and/or Co.

3. The magnetic core according to claim 1, wherein 0.200≤T1≤5.000 is satisfied.

4. A magnetic component comprising the magnetic core according to claim 1.

5. An electronic device comprising the magnetic core according to claim 1.

6. A magnetic core comprising a soft magnetic metal particle, wherein
the soft magnetic metal particle comprises an oxide phase at a surface of the soft magnetic metal particle, and
0<T4/T3≤0.98 is satisfied, where
T3 denotes a length of a maximum-thickness portion of the oxide phase,
T4 denotes a length of an opposite maximum-thickness portion of the oxide phase,
the maximum-thickness portion denotes a portion where a length of the oxide phase along a specific straight line is maximized,
the opposite maximum-thickness portion denotes a portion opposite the maximum-thickness portion relative to a center of the soft magnetic metal particle along the specific straight line, and
the specific straight line denotes a freely drawn straight line containing the center and the maximum-thickness portion in a cross-section of the magnetic core.

7. The magnetic core according to claim 6, wherein the soft magnetic metal particle comprises Fe and/or Co.

8. The magnetic core according to claim 6, wherein 0<T4/T3≤0.90 is satisfied.

9. A magnetic component comprising the magnetic core according to claim 6.

10. An electronic device comprising the magnetic core according to claim 6.
